(19) United States
(12) Patent Application Publication
(10) Pub. No.: US 2026/0175168 A1
(43) Pub. Date: Jun. 25, 2026

(54) COMPOSITIONS, ARTICLES, AND METHODS RELATED TO REDOX-ACTIVE SORBENTS FOR ELECTROCHEMICAL CARBON DIOXIDE SEPARATION

(71) Applicant: Massachusetts Institute of Technology, Cambridge, MA (US)

(72) Inventors: Betar Gallant, Cambridge, MA (US); Fang-Yu Kuo, Cambridge, MA (US); Glen Junor, Lowell, MA (US); Akachukwu Obi, Cambridge, MA (US)

(73) Assignee: Massachusetts Institute of Technology, Cambridge, MA (US)

(21) Appl. No.: 19/427,212

(22) Filed: Dec. 19, 2025

Related U.S. Application Data
(60) Provisional application No. 63/737,590, filed on Dec. 20, 2024.

(51) Int. Cl. B01D 53/32; B01D 53/14

(52) U.S. Cl. CPC B01D 53/326; B01D 53/1475; B01D 2252/20473; B01D 2257/504; B01D 2258/0283

(57) ABSTRACT

Compositions, articles, systems, and methods related to redox-active sorbents for electrochemical carbon dioxide separation are generally described.

### RELATED APPLICATIONS

This application claims priority under 35 U.S.C. § 119(e) to U.S. Provisional Patent Application No. 63/737,590, filed Dec. 20, 2024, and entitled “Compositions. Articles, and Methods Related to Redox-Active Sorbents for Electrochemical Carbon Dioxide Separation,” which is incorporated herein by reference in its entirety for all purposes.

### TECHNICAL FIELD

Compositions, articles, systems, and methods related to redox-active sorbents for electrochemical carbon dioxide separation are generally described.

### SUMMARY

Generally described herein are compositions, articles, systems, and methods related to redox-active sorbents for electrochemical carbon dioxide separation. The subject matter of the present invention involves, in some cases, interrelated products, alternative solutions to a particular problem, and/or a plurality of different uses of one or more systems and/or articles.

According to some embodiments, an electrochemical cell is described. In certain embodiments, the electrochemical cell comprises: a first electrode; a second electrode; and a carbon dioxide (CO₂) adduct comprising a reaction product between CO₂ and a N-heterocyclic imine (NHI) compound of Formula (I) and/or a metal ion-stabilized derivative thereof:

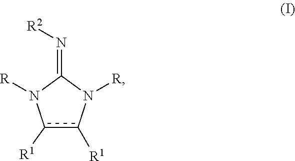

wherein:
each R is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; and/or (iii) at least one R combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iv) each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
   each R¹ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂; and/or (ii) at least one R¹ combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
R² is selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, N(R³)₂, and a NHI moiety, each of which is optionally substituted, and wherein one or more optional substituents comprise a NHI substituent, and
each R³ is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, each of which is optionally substituted.

According to some embodiments, a method is described. In certain embodiments, the method comprises exposing a composition to a fluid stream suspected of comprising CO₂, wherein the composition comprises a NHI compound of Formula (I) and/or a metal ion-stabilized derivative thereof:

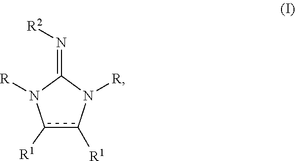

wherein:
each R is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; and/or (iii) at least one R combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iv) each R combines together with the atoms to which they are attached to form a C₃-C₂₀ cycloalkyl group, a C₃-C₄₀ heterocycloalkyl group, a C₆-C₄₀ aryl group, or a C₅-C₄₀ heteroaryl group, each of which is optionally substituted,
each R¹ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₆-C₄₀ heteroaryl, OR³ and N(R³)₂; and/or (ii) at least one R¹ combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
R² is selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, N(R³)₂, and a NHI moiety, each of which is optionally substituted, and wherein one or more optional substituents comprise an NHC substituent, and
   each R³ is the same or different and is individually selected from the group consisting of hydrogen. C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, each of which is optionally substituted.

In some embodiments, the method further comprises: absorbing the CO₂, if present, from the fluid stream, wherein absorbing the CO₂ from the fluid stream comprises reacting the NHI compound of Formula (I) and/or the metal ion-stabilized derivative thereof and the CO₂ to form a CO₂ adduct; and applying a stimulus to release the CO₂ from the CO₂ adduct and regenerate the NHI compound of Formula (I) and/or the metal ion-stabilized derivative thereof.

According to some embodiments, a CO₂ sequestering agent is described. In certain embodiments, the CO₂ sequestering agent comprises a redox-active moiety comprising at least two functional groups capable of binding and releasing CO₂, wherein the at least two functional groups, when the moiety is arranged in a set system, are configured to: (i) bind CO₂ without application of a redox-inducing electrical potential; and (ii) release bound CO₂ upon application of a stimulus, and wherein the moiety is configured to bind and release greater than or equal to 1.4 mol of CO₂ per mol of the CO₂ sequestering agent.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A shows a schematic diagram of an electrochemical cell comprising a CO₂ sequestering agent, in accordance with certain embodiments.

FIG. 1B shows a schematic diagram of an electrochemical cell comprising a CO₂ adduct, in accordance with certain embodiments.

FIG. 1C shows a schematic diagram of an electrochemical cell comprising a CO₂ sequestering agent after releasing CO₂, in accordance with certain embodiments.

FIG. 2A shows synthetic pathways for N-heterocyclic imines (NHIs), in accordance with certain embodiments. Reagents and conditions: 1) R″—NH₂, KF, MeCN, then NaBF₄; 2) KOtBu. THF.

FIG. 2B shows initial substrate scope and nomenclature of NHIs, in accordance with embodiments.

FIG. 3 shows: (i) reaction enthalpy of carbon dioxide (CO₂) and NHIs with various backbones, in accordance with certain embodiments (top); and (ii) shows reaction enthalpy of CO₂ and NHIs with various side chains and exocyclic nitrogen, in accordance with certain embodiments (bottom). Measurements were conducted at 0.1 M NHI concentration in DMSO purged with 1 sccm of 100% CO₂ at 25° C.

FIG. 4A shows a schematic of an experimental setup to measure the CO₂ loading on NHIs, in accordance with certain embodiments.

FIG. 4B shows real-time CO₂ concentration traces during 10 sccm of 15% CO₂ purge into 1 mL of various sorbents (1 M NHI in DMI and 1 M amine in water), in accordance with certain embodiments.

FIG. 4C shows CO₂ loading profiles of various sorbents using 15% CO₂ inlet gas stream concentrations, in accordance with certain embodiments.

FIGS. 4D-4E show CO₂ loading profiles of 4-iPr-iPr using 2.5%, 5%, and 15% CO₂ inlet gas stream concentrations versus time (FIG. 4D) and total CO₂ purged (FIG. 4E).

FIG. 5 shows cyclic voltammograms (CVs) of 1, 2, 3, 4-iPr-iPr, and 5-iPr-iPr under Ar and CO₂, in accordance with certain embodiments. Working electrode: glassy carbon (GC); counter electrode: Pt; and reference electrode: Ag/Ag⁺. The electrolyte contained 0.01 M NHI+0.25 M TBABF₄ in acetonitrile (MeCN). The CV curves were obtained with a scan rate of 50 mV/s.

FIG. 6 shows ¹H NMR spectra of pure NHI (4-iPr-iPr), NHI in TBABF₄/MeCN (rest 2 hours), NHI oxidation in TBABF₄/MeCN. NHI oxidation in LiBF₄/MeCN, and pure NHI-HBF₄ (4-iPr-iPr-HBF₄), in accordance with certain embodiments. Tests are conducted under Ar.

FIG. 7A shows a schematic of an experimental setup for CO₂ release, in accordance with certain embodiments. The H-cell contained NHI-CO₂ solution to be oxidized by a constant current at room temperature and was connected to a gas flow meter and an FT-IR CO₂ sensor. The TEMPO electrolyte on the other side of the H-cell was to be reduced for charge balance.

FIG. 7B shows potential (top) and CO₂ outlet flow rate (bottom) versus time collected during a constant current of 5 mA chronopotentiometry experiment, in accordance with certain embodiments.

FIG. 8 shows CVs of 3 under Ar at the scan rate of 10 mV/s and 50 mV/s, in accordance with certain embodiments. Working electrode: GC; counter electrode: Pt; and reference electrode: Ag/Ag⁺. The electrolyte contained 0.01 M NHI+0.25 M TBABF₄ in MeCN.

FIG. 9 shows voltage (top) and CO₂ outlet flow rate (bottom) versus time during a chronopotentiometry experiment, in accordance with certain embodiments. Catholyte: 0.2 M TEMPO, 0.25 M TBABF₄ in MeCN. Anolyte: 0.2 M NHI 4-iPr-iPr, 0.25 M TBABF₄ in MeCN. 5 mA oxidative current was applied to oxidized NHI in the anolyte.

FIG. 10 shows CO₂ loading of various sorbents using 15% CO₂ inlet gas stream concentrations, in accordance with certain embodiments.

FIG. 11 shows electrochemically mediated CO₂ capture (EMCC) working principles for conventional Lewis bases (reduce-capture system) versus NHI (capture-oxidation system), in accordance with certain embodiments.

FIG. 12A shows the synthesis of phenylene-substituted bis(NHI) 6 and its redox reactions, in accordance with certain embodiments.

FIG. 12B shows CVs of 6 under Ar and CO₂ at 50 mV/s, in accordance with certain embodiments. Working electrode: GC; counter electrode: Pt; and reference electrode: Ag/Ag⁺. The electrolyte contained 0.01 M NHI+0.25 M TBABF₄ or 0.25 M LiBF₄ in MeCN.

FIG. 12C shows a power vs. time trace from micro-reaction calorimetry (μRC) measurement of MeCN and 0.025 M 6 in 0.25 M TBABF₄/MeCN or 0.25 M LiBF₄/MeCN, in accordance with certain embodiments. Testing condition: 25° C. with 1 sccm of 100% CO₂ flow.

FIG. 12D shows CO₂ loading profiles of 0.25 M LiBF₄/MeCN, 0.05 M 6 in 0.25 M LiBF₄/MeCN, and 0.05 M 6^{+′} in 0.25 M LiBF₄/MeCN, in accordance with certain embodiments. Testing condition: 3 mL of sample purged with 5 sccm 15% CO₂.

FIG. 12E shows proposed molecular pathways of CO₂ release from 6-CO₂ and 6-2CO₂ and their corresponding theoretical Faradaic efficiency (FE), in accordance with certain embodiments.

FIG. 13A shows a schematic of the experimental setup for CO₂ release/capture experiments, in accordance with certain embodiments. The working electrode chamber contained 4 ml of 0.05 M 6 in 0.25 M LiBF₄/MeCN and was continuously purged with 2 sccm 15% CO₂. The counter electrode chamber contained 4.5 ml of 0.05 M 6 in 0.25 M LiBF₄/MeCN that is pre-oxidized to 50% state-of-charge (SOC).

FIG. 13B shows FEs in CO₂ capture (reduction) or release (oxidation) with the SOC swing of 10%↔25%, 25%↔40%, and 30%↔50%, in accordance with certain embodiments.

FIG. 13C shows projected speciation changes at various SOCs and the corresponding FEs under the assumption of no specific oxidation/reduction order for 6-CO₂ and 6-2CO₂, in accordance with certain embodiments.

FIG. 13D shows CO₂ readings at the exit of the working electrode chamber over 40 repeated capture and release cycles of 15↔35% SOC swing under 13% CO₂+3% O₂, in accordance with certain embodiments.

FIG. 13E shows corresponding voltage-capacity curves, in accordance with certain embodiments. Ag/Ag⁺ reference electrode was used for recording the working electrode potential. Experiments were conducted at a current of 7.5 mA.

FIG. 14 shows a CV of 6 under 15% CO₂ at 50 mV/s, in accordance with certain embodiments. The scan started at OCV (−0.65 V vs. Fc/Fc⁺) and first scanned positively. Working electrode: GC: counter electrode: Pt; and reference electrode: Ag/Ag⁺. The electrolyte contained 0.025 M 6+0.25 M LiBF₄ in MeCN.

FIG. 15A shows CO₂ flow rate versus time, in accordance with certain embodiments. Test conditions: 5 sccm of 100% CO₂ purged to 3 mL of 0.25 M LiBF₄/MeCN or 0.025 M 6 in 0.25 M LiBF₄/MeCN. Initial headspace: Ar.

FIG. 15B shows the integrated amount of dissolved CO₂ in the solution over time, in accordance with certain embodiments.

FIG. 16 shows CO₂ outlet flow rate as a function of time during the oxidation of 6-2CO₂ under 100% CO₂ atmosphere, in accordance with certain embodiments. A two-electrode H-cell contained 4 mL of 6 in 0.25 M LiBF₄ in MeCN as the anolyte and 4.5 mL of 0.025 M 6^{+·} in 0.25 M LiBF₄ in MeCN as the catholyte. Prior to oxidation, the anolyte was purged and saturated with 100% CO₂ to fully convert 6 to 6-2CO₂. During electrolysis, the cell headspace was continuously purged with 0.1 sccm of 100% CO₂, and a constant current of 10 mA was applied for 900 s (2.5 mAh or 47% SOC) at room temperature. The gas outlet was connected to a gas flow meter to monitor CO₂ release. Both working and counter electrodes were carbon paper.

FIG. 17A shows an experimental configuration of a flow cell setup, in accordance with certain embodiments.

FIG. 17B shows cell voltage of a flow cell during the SOC swing between 15 and 35% at the current of 10 mA (˜2 mA cm⁻²), in accordance with certain embodiments.

FIG. 18 shows a summary of selected EMCC processes, in accordance with certain embodiments.

### DETAILED DESCRIPTION

Compositions, articles, systems, and methods related to redox-active sorbents for electrochemical carbon dioxide (CO₂) separation are generally described. Compositions, articles, and/or systems are provided, including those that are surprisingly thermodynamically and/or energy favorable, and/or those that provide appreciably high levels of CO₂ adsorption per unit of composition, adduct, and/or derivative thereof.

According to one aspect, a CO₂ sequestering agent is described. In certain embodiments, the CO₂ sequestering agent advantageously absorbs CO₂ spontaneously, under conditions requiring simple handling and low energy input (e.g., under ambient conditions such as room temperature and atmospheric pressure), thereby forming a stable CO₂ adduct comprising a reaction product between CO₂ and the CO₂ sequestering agent. For example, the CO₂ sequestering agent can be selected and arranged to react with CO₂ via one or more bonding interactions without the need for externally applied energy (e.g., electrochemical energy), enabling passive CO₂ capture (although electrochemical energy can be applied in other embodiments). This spontaneous, energy-independent CO₂ absorption stands in contrast to conventional electrochemical CO₂ capture systems, which typically require prior electrochemical reduction or activation of the sorbent to generate a reactive species capable of binding CO₂, thereby increasing system complexity and energy demand.

According to some embodiments, the CO₂ sequestering agents described herein comprise N-heterocyclic imine compounds having tunable degrees of functionality, for example, on a backbone of the N-heterocyclic imine core, on the side chain of the N-heterocyclic imine core, and/or on the exocyclic (e.g., imine) nitrogen atom. In some embodiments, the degree of functionality of the N-heterocyclic imine compounds modulates the CO₂ loading of the compounds, thereby advantageously enabling adjustable CO₂ absorption capacities across a family of related structures.

In some embodiments, the CO₂ sequestering agent comprises a redox-active moiety, such as a N-heterocyclic imine core, configured to undergo reversible redox reactions. In certain embodiments, upon application of a stimulus (e.g., an electrical potential), the CO₂ adduct may: (i) release bound CO₂ (e.g., via oxidation of the redox-active moiety); and (ii) regenerate the CO₂ sequestering agent (e.g., via reduction of the oxidized redox-active moiety).

Conventional electrochemical CO₂ capture and release agents comprise redox-active species whose potentials fall within ranges that exhibit undesirable overlap with oxygen reduction potentials. According to some embodiments, the CO₂ sequestering agents described herein advantageously have a greater (e.g., more positive) redox potential (e.g., reduction potential) than that of oxygen, thereby avoiding oxygen reduction reactions that form undesired oxygen-reduction byproducts, improving Faradaic efficiency, and minimizing parasitic charge consumption.

In some embodiments, the CO₂ sequestering agent comprises at least two functional groups that are capable of binding and releasing CO₂. In some embodiments, for example, the CO₂ sequestering agent comprises a compound comprising multiple N-heterocyclic imine moieties, each moiety configured to bind and release CO₂. In some embodiments, the CO₂ sequestering agent is configured to bind and release an advantageously high amount of CO₂ per mole of the CO₂ sequestering agent, such as greater than or equal to 1.4 moles of CO₂ (e.g., 2 moles of CO₂) per mole of the CO₂ sequestering agent.

The CO₂ capture and release compositions, articles, systems, and methods described herein may be used for any of a variety of suitable environmental and/or industrial applications, including, but not limited to, CO₂ emission mitigation and/or direct air capture processes.

In certain embodiments, the CO₂ sequestering agent comprises a redox-active moiety. As used herein, a redox-active moiety refers to a chemical moiety that is capable of undergoing a reversible change in oxidation state. In certain embodiments the redox-active moiety is electrochemically active, such that the chemical moiety can accept and/or donate electrons when subjected to an applied potential.

The redox-active moiety may be any of a variety of suitable species. In some embodiments, the redox-active moiety comprises a conjugated heterocycle. In some embodiments, the redox-active moiety comprises a conjugated N-heterocycle. In certain embodiments, the redox-active moiety comprises an imidazolyl, tiazolyl, a benzimidazolyl, and the like. In some embodiments, the redox-active moiety comprises a N-heterocyclic imine core, including a conjugated N-heterocycle and a C═N unit that participates in reversible electron-transfer processes. Other redox-active moieties are also possible.

According to some embodiments, the redox-active moiety comprises at least one functional group that is capable of binding CO₂ through one or more bonding interactions. In certain embodiments, the redox-active moiety comprises at least two functional groups, at least three functional groups, at least four functional groups, at least five functional groups, or more, that are capable of binding CO₂ through one or more bonding interactions. The one or more bonding interactions may be any of a variety of suitable interactions, including, for example, non-covalent interactions and/or electrostatic interactions (e.g., Coulombic interactions).

In certain embodiments, when the redox-activity moiety is arranged in a set system, the functional group arrangement, i.e., at least one functional group (e.g., two functional groups, three functional groups, four functional groups, five functional groups, or more) is capable of binding CO₂ without application of a redox-inducing potential, or application of a low potential, if a potential is applied at all. As used herein, a set system refers to the operational arrangement in which the redox-active moiety is incorporated into its intended environment and subjected to the conditions described herein, such that the redox activity moiety and one or more functional groups act cooperatively in that context. In some embodiments, the functional group arrangement is capable of binding CO₂ spontaneously. This CO₂ binding can occur under ambient conditions (e.g., about 20-30° C. and from about 0.8 to 1.2 atm, or in some systems at about 1 atm) without the need for externally supplied energy (e.g., thermal, photochemical, and/or electrochemical energy).

In certain embodiments, the redox-active moiety comprises at least one functional group that is capable of releasing CO₂ upon application of a stimulus. In certain embodiments, the redox-active moiety comprises at least two functional groups, at least three functional groups, at least four functional groups, at least five functional groups, or more, that are capable of releasing CO₂ upon application of a stimulus. Suitable stimuli are described herein in greater detail, including, for example, application of an electrical potential or a salt exchange process.

In certain embodiments, when the redox-activity moiety is arranged in a set system, the at least one functional group (e.g., two functional groups, three functional groups, four functional groups, five functional groups, or more) is capable of releasing bound CO₂ upon application of a stimulus.

In some embodiments, the redox-active moiety comprises at least one functional group that is capable of binding and releasing CO₂. In certain embodiments, the at least one functional group, when the redox-active moiety is arranged in a set system, is configured to: (i) bind CO₂ without application of a redox-inducing electrical potential; and (ii) release bound CO₂ upon application of a stimulus. In certain embodiments, the redox-active moiety comprises at least at least two functional groups capable of binding and releasing CO₂. In certain embodiments, the at least two functional groups, when the redox-active moiety is arranged in a set system, are configured to: (i) bind CO₂ without application of a redox-inducing electrical potential; and (ii) release bound CO₂ upon application of a stimulus.

The redox-activity moiety may be configured to bind and release any of a variety of suitable amounts of CO₂. In some embodiments, for example, the redox-active moiety is configured to bind and release greater than or equal to 0.1 mol of CO₂, greater than or equal to 0.5 mol of CO₂, greater than or equal to 0.8 mol of CO₂, greater than or equal to 1 mol of CO₂, greater than or equal to 1.2 mol of CO₂, greater than or equal to 1.4 mol of CO₂, greater than or equal to 1.6 mol of CO₂, greater than or equal to 1.8 mol of CO₂, or greater than or equal to 2 mol of CO₂ per mol of the CO₂ sequestering agent. In certain embodiments, the redox-active moiety is configured to bind and release less than or equal to 2.5 mol of CO₂, less than or equal to 2 mol of CO₂, less than or equal to 1.8 mol of CO₂, less than or equal to 1.6 mol of CO₂, less than or equal to 1.4 mol of CO₂, less than or equal to 1.2 mol of CO₂, less than or equal to 1 mol of CO₂, less than or equal to 0.8 mol of CO₂, or less than or equal to 0.5 mol of CO₂ per mol of the CO₂ sequestering agent. Combinations of the above recited ranges are also possible (e.g., the redox-active moiety is configured to bind and release greater than or equal to 0.1 mol of CO₂ and less than or equal to 2.5 mol of CO₂ per mol of the CO₂ sequestering agent). Other ranges are also possible.

In certain embodiments, the CO₂ sequestering agent comprises a N-heterocyclic imine (NHI) compound of Formula (I):

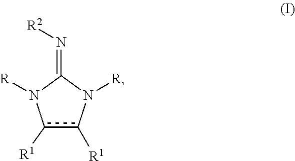

According to some embodiments, each R is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl. C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; and/or (iii) at least one R combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iv) each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In certain embodiments, each R¹ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocyclically, C₆-C₄₀ aryl, C₅-C₄₀ heteroaryl, OR³, and N(R³)₂; and/or (ii) at least one R¹ combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In some embodiments, R² is selected from the group consisting of hydrogen, C₁-C₂₀ alkyl. C₂-C₂₀ alkenyl, C₃-C₂₀ alkynyl, C₃-C₂₀ cycloalkyl, C₃-C₂₀ heterocycloalkyl. C₆-C₄₀ aryl, C₅-C₄₀ heteroaryl, OR³, N(R³)₂, and a NHI moiety, each of which is optionally substituted. In certain embodiments, one or more optional substituents comprise a NHI substituent.

According to certain embodiments, each R³ is the same or different and is individually selected from the group consisting of hydrogen, C₁-C₂₀ alkyl, C₂-C₂₀ alkenyl. C₃-C₂₀ alkynyl, C₃-C₂₀ cycloalkyl, C₃-C₂₀ heterocycloalkyl. C₆-C₄₀ aryl, C₅-C₄₀ heteroaryl, each of which is optionally substituted.

According to some embodiments, each R is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted. In certain non-limiting embodiments, each R is individually selected from the group consisting of a methyl group, an isopropyl group, and a tert-butyl group.

In certain embodiments, at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In some embodiments wherein at least one R combines together with at least one R¹ and the atoms to which they are attached, the CO₂ sequestering agent comprises:

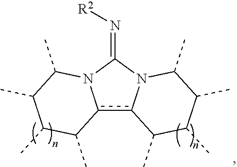

wherein each n is the same or different and is individually greater than or equal to 1 and less than or equal to 10.

In some embodiments wherein at least one R combines together with at least one R¹ and the atoms to which they are attached, the CO₂ sequestering agent comprises:

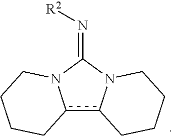

In some embodiments wherein at least one R combines together with at least one R¹ and the atoms to which they are attached, the CO₂ sequestering agent comprises:

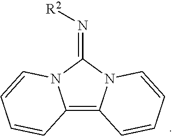

In certain embodiments, at least one R combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In certain embodiments wherein at least one R combines together with R² and the atoms to which they are attached, the CO₂ sequestering agent comprises:

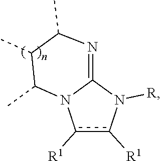

wherein n is greater than or equal to 1 and less than or equal to 10.

In certain embodiments wherein at least one R combines together with R² and the atoms to which they are attached, the CO₂ sequestering agent comprises:

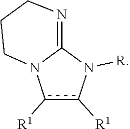

In some embodiments wherein at least one R combines together with R² and the atoms to which they are attached, the CO₂ sequestering agent comprises:

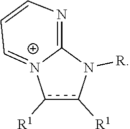

In some embodiments wherein at least one R combines together with R² and the atoms to which they are attached, the CO₂ sequestering agent comprises:

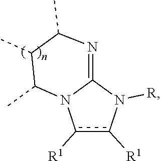

wherein n is greater than or equal to 1 and less than or equal to 10.

In some embodiments wherein at least one R combines together with R² and the atoms to which they are attached, the CO₂ sequestering agent comprises:

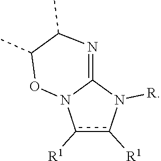

In some embodiments wherein at least one R combines together with R² and the atoms to which they are attached, the CO₂ sequestering agent comprises:

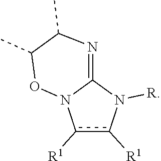

According to some embodiments, each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

According to some embodiments wherein each R combines together with the atoms to which they are attached, the CO₂ sequestering agent comprises:

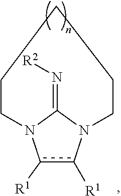

wherein n is greater than or equal to 1 and less than or equal to 10.

In certain embodiments, each R¹ is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂. In some non-limiting embodiments, each R¹ is individually selected from the group consisting of hydrogen, a methyl group, and a phenyl group.

According to some embodiments, at least one R¹ combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

According to some embodiments wherein at least one R¹ combines together with R² and the atoms to which they are attached, the CO₂ sequestering agent comprises:

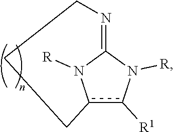

wherein n is greater than or equal to 1 and less than or equal to 10.

In certain embodiments, each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In some embodiments wherein each R¹ combines together with the carbon atoms to which they are attached, the CO₂ sequestering agent comprises:

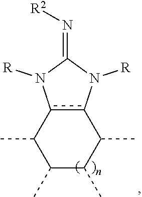

wherein n is greater than or equal to 1 and less than or equal to 2

In some embodiments, R² is selected from the group consisting of hydrogen, C₁-C₂₀ alkyl, C₂-C₂₀ alkenyl, C₃-C₂₀ alkynyl. C₃-C₂₀ cycloalkyl, C₃-C₂₀ heterocycloalkyl, C₆-C₄₀ aryl. C₅-C₄₀ heteroaryl, OR³, and N(R³)₂, each of which is optionally substituted. In certain non-limiting embodiments, R² is selected from the group consisting of a methyl group, an isopropyl group, and a tert-butyl group.

According to some embodiments, R² is an optionally substituted NHI moiety. In certain embodiments, for example, R² is:

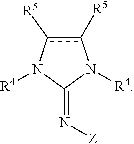

In certain embodiments, each R⁴ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R⁴ combines together with at least one R₅ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R⁴ combines together with the atoms to which they are attached to form a C₃-C₂₀ cycloalkyl group, a C₃-C₂₀ heterocyclocalkyl group, a C₆-C₄₀ aryl group, or a C₅-C₄₀ heteroaryl group, each of which is optionally substituted.

In some embodiments, each R⁵ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; or (ii) each R⁵ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In some embodiments, Z represents a bond to the NHI compound of Formula (I).

In certain embodiments, each R⁴ is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted.

In certain embodiments, at least one R⁴ combines together with at least one R⁵ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

According to some embodiments, each R⁴ combines together with the atoms to which they are attached to form a C₃-C₂₀ cycloalkyl group, a C₃-C₂₀ heterocyclocalkyl group, a C₆-C₄₀ aryl group, or a C₅-C₄₀ heteroaryl group, each of which is optionally substituted.

In some embodiments, each R⁵ is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted.

In certain embodiments, each R⁵ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

According to some embodiments, R² is selected from the group consisting of C₆-C₄₀ aryl and C₅-C₄₀ heteroaryl, each of which is optionally substituted. In certain embodiments, one or more optional substituents comprise the NHI substituent. According to some embodiments, R² is selected from the group consisting of C₆-C₄₀ aryl and C₅-C₄₀ heteroaryl, each of which is substituted. In some embodiments, one or more substituents comprise the NHI substituent.

In certain embodiments, R² is selected from the group consisting of a phenyl group, a naphthyl group, a dihydroanthracenyl group, an anthraquinonyl group, an anthracenyl group, a furyl group, a pyrrolyl group, and a thienyl group.

According to some embodiments, R² is selected from the group consisting of:

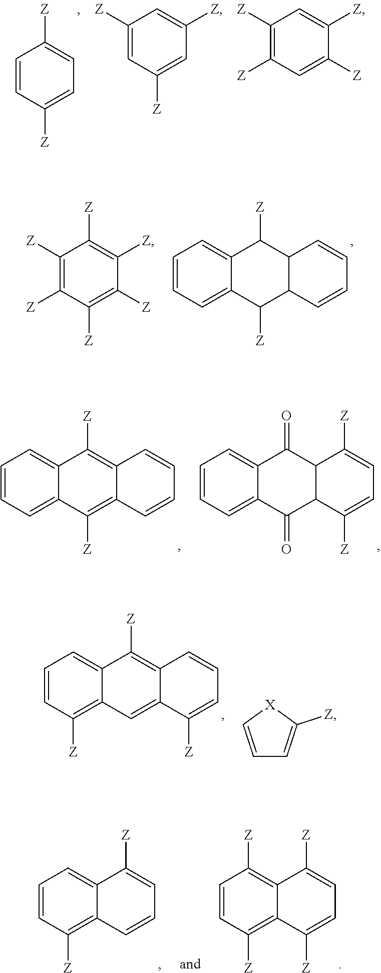

According to some embodiments, one Z in each structure represents a bond to the NHI compound of Formula (I) and each remaining Z, if present, represents a bond to the NHI substituent.

In certain embodiments, X is selected from the group consisting of O, N, and S.

According to some embodiments, the NHI compound of Formula (I) is:

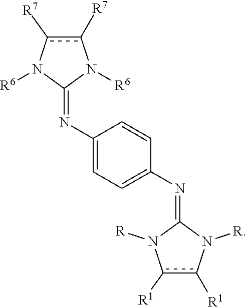

In some embodiments, each R in the compound is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

According to some embodiments, each R¹ is the same or different and: (i) is individually selected from the group consisting of hydrogen, C₁-C₂₀ alkyl, C₂-C₂₀ alkenyl. C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; or (ii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In certain embodiments, each R⁶ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R⁶ combines together with at least one R⁷ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R⁶ combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

In some embodiments, each R⁷ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; or (ii) each R⁷ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

According to some embodiments, the CO₂ sequestering agent (e.g., the NHI compound of Formula (I)) may be synthesized using urea, imidazolium salts, and/or thiourea as starting materials. In certain embodiments, the starting materials are used to synthesize 2-chloroazolium salts, which are then reacted with an amine to produce N-heterocyclic iminium salts. In certain embodiments, treatment of the N-heterocyclic imine salt with a base (e.g., KOtBu, KOH, and the like) produces the CO₂ sequestering agent.

In one aspect, a metal ion-stabilized derivative of the CO₂ sequestering agent is provided. For example, the CO₂ sequestering agent can comprise a metal ion-stabilized derivative of the NHI compound of Formula (I). As used herein, a metal ion-stabilized derivative of the CO₂ sequestering agent can be a species in which the CO₂ sequestering agent is associated with a metal cation, e.g., is coordinated to, ion-paired with, and/or otherwise configured with respect to a metal cation such that the metal cation stabilizes a charged and/or reactive form of the CO₂ sequestering agent. In certain embodiments, the CO₂ sequestering agent is associated with the metal cation through non-covalent interactions, hydrogen bonding, electrostatic interactions (e.g., Coulombic interactions), and/or other bonding interactions that stabilize the electronic structure, charge state, and/or reactivity of the CO₂ sequestering agent.

The metal ion-stabilized derivative of the CO₂ sequestering agent (e.g., the NHI compound of Formula (I)) may be stabilized by any of a variety of suitable metal ions. In some embodiments, for example, the metal ion-stabilized derivative of the CO₂ sequestering agent is stabilized by an alkali metal ion, an alkaline earth metal ion, a transition metal ion, a post-transition metal ion, a lanthanide ion, and/or an actinide ion.

In certain embodiments, the metal ion-stabilized derivative of the CO₂ sequestering agent (e.g., the NHI compound of Formula (I)) is a lithium ion-, a sodium ion-, a potassium ion-, a cesium ion-, a magnesium ion-, a calcium ion-, an aluminum ion-, a zinc-, and/or a cadmium ion-stabilized derivative of the CO₂ sequestering agent (e.g., the NHI compound of Formula (I)). Other metal ion-stabilized derivatives of the CO₂ sequestering agent are also possible.

In some embodiments, the metal ion of the metal ion-stabilized derivative of the CO₂ sequestering agent (e.g., the NHI compound of Formula (I)) comprises a lithium ion, a sodium ion, a potassium ion, a cesium ion, a magnesium ion, a calcium ion, an aluminum ion, a zinc ion, and/or a cadmium ion. Other metal ions are also possible.

As used throughout the remainder of this disclosure, the term “CO₂ sequestering agent” refers to the CO₂ sequestering agent and/or a metal ion-stabilized derivative thereof, unless otherwise indicated.

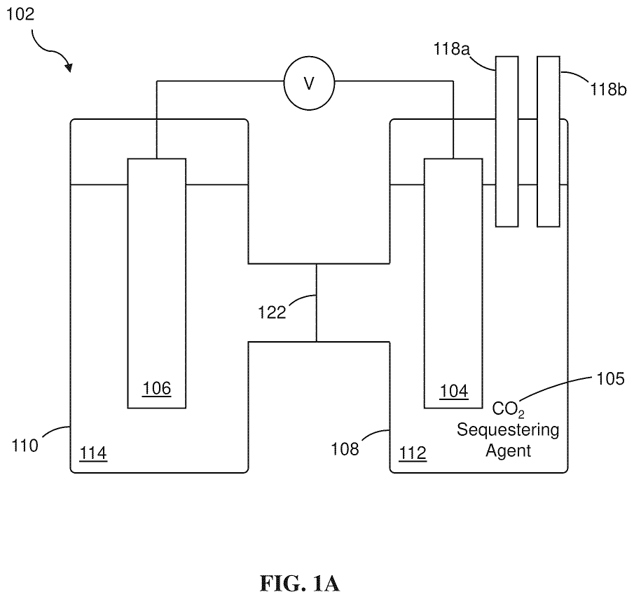

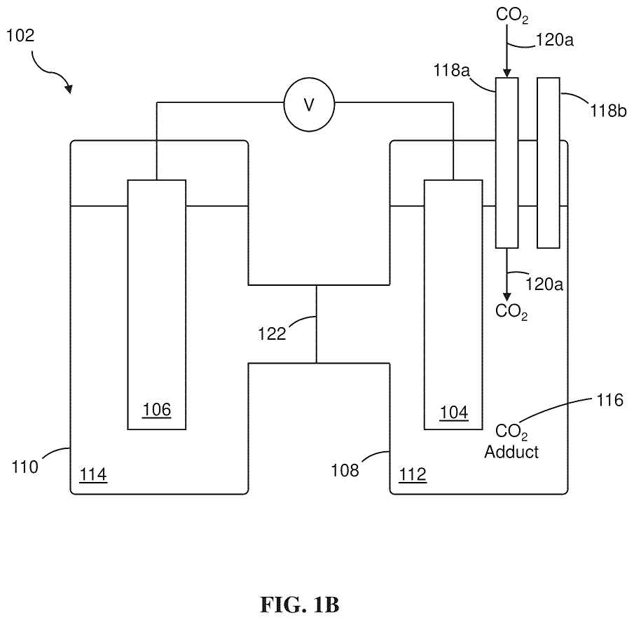

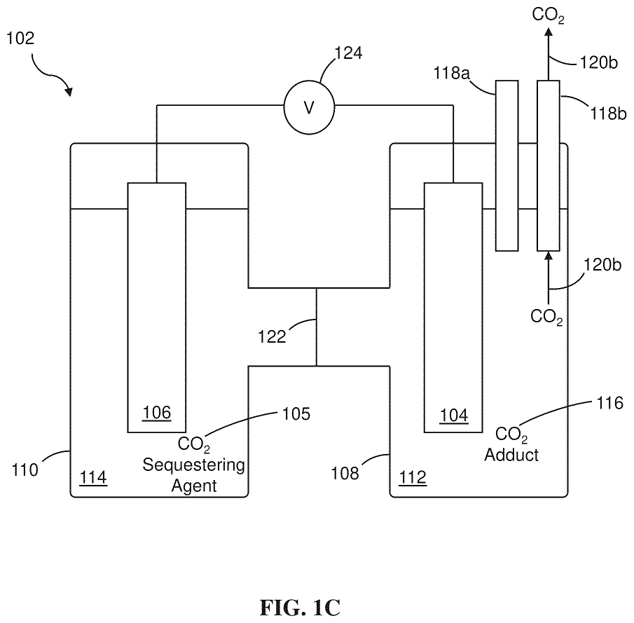

According to some embodiments, an electrochemical cell is described. FIG. 1A shows a schematic diagram of electrochemical cell 102, in accordance with certain embodiments. According to certain embodiments, the electrochemical cell is a flow cell. For example, referring to FIG. 1A, electrochemical cell 102 is a flow cell. As used herein, a flow cell refers to a system comprising at least one compartment configured to receive fluid through an inlet and direct the fluid through the compartment for reaction before exiting through an outlet. In some embodiments, as shown in FIG. 1A, electrochemical cell comprises fluid conduits 118a and 118b, which may serve as fluid inlets and outlets, respectively.

According to some embodiments, the electrochemical cell comprises a first electrode and a second electrode. Referring, for example, to FIG. 1A, electrochemical cell 102 comprises first electrode 104 and second electrode 106. According to some embodiments, the electrochemical cell (e.g., electrochemical cell 102) is an asymmetric electrochemical cell comprising a first electrode (e.g., first electrode 104) and a second electrode (e.g., second electrode 106) that differ in composition, structure, ion-storage characteristics, and/or redox potential.

According to certain embodiments, the first electrode is an anode. In some embodiments, the second electrode is a cathode.

The first electrode (e.g., first electrode 104) may comprise any of a variety of suitable materials. In some embodiments, for example, the first electrode comprises a carbon material (e.g., carbon felt, carbon paper, graphite, glassy carbon, etc.), a metal (e.g., platinum, gold, silver, nickel, stainless steel, titanium, etc.), and/or a metal oxide (e.g., indium tin oxide, fluorine-doped tin oxide, ruthenium oxide, iridium oxide, nickel oxide, etc.). In certain embodiments, the first electrode comprises a composite electrode, for example, comprising a polymer and a carbon material, a metal, and/or a metal oxide. In some embodiments, the first electrode comprises a material (e.g., a polymer) coated with a carbon material, a metal, and/or a metal oxide. Other materials are also possible.

The second electrode (e.g., second electrode 106) may comprise any of a variety of suitable materials. In certain embodiments, for example, the second electrode comprises a carbon material (e.g., carbon felt, carbon paper, graphite, glassy carbon, etc.), a metal (e.g., platinum, gold, silver, nickel, stainless steel, titanium, etc.), and/or a metal oxide (e.g., indium tin oxide, fluorine-doped tin oxide, ruthenium oxide, iridium oxide, nickel oxide, etc.). In certain embodiments, the second electrode comprises a composite electrode, for example, comprising a polymer and a carbon material, a metal, and/or a metal oxide. In some embodiments, the second electrode comprises a material (e.g., a polymer) coated with a carbon material, a metal, and/or a metal oxide. Other materials are also possible.

In some embodiments, the first electrode is contained within a first compartment.

Referring, for example, to FIG. 1A, first electrode 104 is contained within first compartment 108.

According to some embodiments, the first compartment comprises a first electrolyte. For example, referring to FIG. 1A, first compartment 108 comprises first electrolyte 112.

The first electrolyte may comprise any of a variety of suitable electrolyte solvents. In some embodiments, for example, the first electrolyte comprises a non-aqueous liquid. Suitable non-aqueous liquids include, but are not limited to, nitriles (e.g., acetonitrile (MeCN)), amides (e.g., dimethylformamide (DMF), dimethylacetamide (DMA), etc.), sulfoxides (e.g., dimethyl sulfoxide (DMSO)), cyclic carbonates (e.g., polypropylene carbonate (PC), ethylene carbonate (EC), etc.), ethers (e.g., tetrahydrofuran (THF), diglyme, 1,2-dimethoxyethane (DME), etc.), and/or ionic liquids. Other non-aqueous liquids are also possible. In some embodiments, the first electrolyte comprises an aqueous liquid.

In certain embodiments, the first electrolyte comprises an electrolyte salt. In some embodiments, the electrolyte salt is dissolved in solution (e.g., in the non-aqueous liquid and/or the aqueous liquid). Suitable electrolyte salts include, but are not limited to, tetraalkylammonium salts (e.g., tetrabutylammonium tetrafluoroborate (TBABF₄), tetrabutylammonium hexafluorophosphate (TBAPF₆), etc.) imidazolium or pyrrolidinium salts (e.g., 1-ethyl-3-methylimidazolium tetrafluoroborate (EMIMBF₄), 1-ethyl-3-methylimidazolium bis(trifluoromethanesulfonyl)imide (EMIMTFSI), etc.), and/or alkali metal salts (e.g., lithium tetrafluoroborate (LiBF₄), lithium hexafluorophosphate (LiPF₆), lithium bis(trifluoromethanesulfonyl)imide (LiTFSI), etc.). Other electrolyte salts are also possible for the first electrolyte.

In certain embodiments, the second electrode is contained within a second compartment. For example, referring to FIG. 1A, second electrode 106 is contained within second compartment 110.

According to certain embodiments, the second compartment comprises a second electrolyte. Referring, for example, to FIG. 1A, second compartment 110 comprises second electrolyte 114.

In some embodiments, the second electrolyte (e.g., second electrolyte 114) is different than the first electrolyte (e.g., first electrolyte 112). For example, in certain embodiments, the second electrolyte has a different chemical composition than the first electrolyte. In some embodiments, the second electrolyte comprises a different electrolyte solvent, a different electrolyte salt(s), and/or a different concentration of an electrolyte salt than the first electrolyte.

The second electrolyte may comprise any of a variety of suitable electrolyte solvents. In certain embodiments, for example, the second electrolyte comprises a non-aqueous liquid. Suitable non-aqueous liquids include, but are not limited to, nitriles (e.g., acetonitrile (MeCN)), amides (e.g., dimethylformamide (DMF), dimethylacetamide (DMA), etc.), sulfoxides (e.g., dimethyl sulfoxide (DMSO)), cyclic carbonates (e.g., polypropylene carbonate (PC), ethylene carbonate (EC), etc.), ethers (e.g., tetrahydrofuran (THF), diglyme, 1,2-dimethoxyethane (DME), etc.), and/or ionic liquids. Other non-aqueous liquids are also possible. In some embodiments, the second electrolyte comprises an aqueous liquid.

In certain embodiments, the second electrolyte comprises an electrolyte salt. In some embodiments, the electrolyte salt is dissolved in solution (e.g., in the non-aqueous liquid and/or the aqueous liquid). Suitable electrolyte salts include, but are not limited to, tetraalkylammonium salts (e.g., tetrabutylammonium tetrafluoroborate (TBABF₄), tetrabutylammonium hexafluorophosphate (TBAPF₆), etc.) imidazolium or pyrrolidinium salts (e.g., 1-ethyl-3-methylimidazolium tetrafluoroborate (EMIMBF₄), 1-ethyl-3-methylimidazolium bis(trifluoromethanesulfonyl)imide (EMIMTFSI), etc.), and/or alkali metal salts (e.g., lithium tetrafluoroborate (LiBF₄), lithium hexafluorophosphate (LiPF₆), lithium bis(trifluoromethanesulfonyl)imide (LiTFSI), etc.). Other electrolyte salts are also possible for the second electrolyte.

According to some embodiments, the first electrolyte and/or the second electrolyte may comprise a redox mediator additive. In some embodiments, the redox mediator is configured to facilitate indirect electrochemical oxidation, thereby reducing electrode overpotential and improving reaction efficiency. Suitable redox mediators include, but are not limited to, nitroxyl radicals (e.g., 2,2,6,6-tetramethylpiperidin-1-oxyl (TEMPO). Other redox mediators are also possible.

According to some embodiments, the electrochemical cell comprises a separator. Referring, for example, to FIG. 1A, electrochemical cell 102 comprises separator 122. In some embodiments, the separator is an ion-permeable barrier configured to electrically isolate the first electrode and the second electrode and/or the first compartment and the second compartment while permitting selective transport of ions and/or fluid species between them. In certain embodiments, the separator permits selective transport of an electrolyte salt (e.g., between the first compartment and the second compartment). In some embodiments, the separator permits selective transport of the CO₂ sequestering agent and/or redox-active derivatives thereof (e.g., between the first compartment and the second compartment).

The separator may comprise any of a variety of suitable materials. In certain embodiments, for example, the separator comprises an anion exchange membrane (AEM). In certain embodiments, for example, the separator comprises a polymer functionalized with positively charged functional groups (e.g., ammonium, phosphonium, imidazolium, etc.). In some embodiments, the separator comprises a cation exchange membrane (CEM). For example, in some embodiments, the separator comprises a polymer functionalized with negatively charged functional groups (e.g., sulfonate, carboxylate, phosphonate, etc.). Other materials are also possible.

In certain embodiments, the electrochemical cell comprises a CO₂ sequestering agent. For example, in some embodiments, the electrochemical cell comprises a NHI compound of Formula (I) and/or a metal ion-stabilized derivative thereof. Referring, for example, to FIG. 1A, electrochemical cell 102 comprises CO₂ sequestering agent 105 (e.g., a NHI compound of Formula (I) and/or a metal ion-stabilized derivative thereof).

According to some embodiments, the CO₂ sequestering agent (e.g., CO₂ sequestering agent 105) is dissolved in solution. In some embodiments, for example, the first electrolyte (e.g., contained within the first compartment) comprises the CO₂ sequestering agent. For example, referring to FIG. 1A, first electrolyte 112 (e.g., contained within first compartment 108) comprises CO₂ sequestering agent 105. In certain embodiments, the CO₂ sequestering agent is synthesized as a solid material and subsequently dissolved in solution (e.g., in the first electrolyte). In other embodiments, the CO₂ sequestering agent is generated in situ (e.g., in the first electrolyte).

According to some embodiments, as described herein in greater detail, the CO₂ sequestering agent is configured to absorb CO₂. In certain embodiments, for example, upon exposure to CO₂, the CO₂ sequestering agent is configured to absorb CO₂ and form a CO₂ adduct comprising a reaction product between CO₂ and the CO₂ sequestering agent. In some embodiments, upon exposure to CO₂, the NHI compound of Formula (I) and/or the metal ion-stabilized derivative thereof is configured to absorb CO₂ and form a CO₂ adduct comprising a reaction product between CO₂ and the NHI compound of Formula (I) and/or the metal ion-stabilized derivative thereof.

In certain embodiments, the NHI compound of Formula (I) and/or the metal ion-stabilized derivative thereof reacts with CO₂ through one or more bonding interactions. In some embodiments, for example, the one or more bonding interactions comprise non-covalent interactions and/or electrostatic interactions (e.g., Coulombic interactions). In certain embodiments, the NHI compound of Formula (I) and/or the metal ion-stabilized derivative thereof reacts with CO₂ at an exocyclic (e.g., imine) nitrogen atom. In some embodiments, the NHI compound of Formula (I) and/or the metal ion-stabilized derivative thereof reacts with CO₂ through the R² group bonded to the exocyclic (e.g., imine) nitrogen atom.

According to some embodiments, the absorption (e.g., reaction) of CO₂ by the CO₂ sequestering agent (e.g., the NHI compound of Formula (I) and/or the metal ion-stabilized derivative thereof) occurs spontaneously. In some embodiments, for example, the absorption of CO₂ by the CO₂ sequestering agent (e.g., the NHI compound of Formula (I) and/or the metal ion-stabilized derivative thereof) occurs under ambient conditions (e.g., about 20-30° C., and about 1 atm) without the need for externally supplied energy (e.g., thermal, photochemical, and/or electrochemical energy).

In one aspect, a metal ion-stabilized derivative of the CO₂ adduct is provided. For example, the CO₂ adduct can comprise a metal ion-stabilized derivative of the reaction product between CO₂ and the NHI compound of Formula (I) and/or the metal ion-stabilized derivative thereof. As used herein, a metal ion-stabilized derivative of the CO₂ adduct can be a species in which the CO₂ adduct is associated with a metal cation, e.g., is coordinated to, ion-paired with, and/or otherwise configured with respect to a metal cation such that the metal cation stabilizes a charged and/or reactive form of the CO₂ adduct. In certain embodiments, the CO₂ adduct is associated with the metal cation through non-covalent interactions, hydrogen bonding, electrostatic interactions (e.g., Coulombic interactions), and/or other bonding interactions that stabilize the electronic structure, charge state, and/or reactivity of the CO₂ adduct.

The metal ion-stabilized derivative of the CO₂ adduct may be stabilized by any of a variety of suitable metals. For example, in some embodiments, the metal ion-stabilized derivative of the CO₂ adduct is stabilized by an alkali metal ion, an alkaline earth metal ion, a transition metal ion, a post-transition metal ion, a lanthanide ion, and/or an actinide ion.

In certain embodiments, the metal ion-stabilized derivative of the CO₂ adduct is a lithium ion-, a sodium ion-, a potassium ion-, a cesium ion-, a magnesium ion-, a calcium ion-, an aluminum ion-, a zinc ion-, and/or a cadmium ion-stabilized derivative of the CO₂ adduct. Other metal ion-stabilized derivatives of the CO₂ adduct are also possible.

In some embodiments, the metal ion of the metal ion-stabilized derivative of the CO₂ adduct comprises a lithium ion, a sodium ion, a potassium ion, a cesium ion, a magnesium ion, a calcium ion, an aluminum ion, a zinc ion, and/or a cadmium ion. Other metal ions are also possible.

As used throughout the remainder of this disclosure, the term “CO₂ adduct” refers to the CO₂ adduct and/or a metal ion-stabilized derivative thereof, unless otherwise indicated.

In some embodiments, the electrochemical cell comprises the CO₂ adduct. FIG. 1B shows a schematic diagram of electrochemical cell 102 comprising CO₂ adduct 116, in accordance with certain embodiments. In certain embodiments, upon exposure to a fluid stream comprising CO₂ (e.g., via a fluid conduit), the CO₂ sequestering agent (e.g., the NHI compound of Formula (I) and/or the metal ion-stabilized derivative thereof) is configured to absorb CO₂ and form the CO₂ adduct. For example, referring to FIG. 1B, upon exposure to fluid stream 120a comprising CO₂ (e.g., via fluid conduit 118a), the CO₂ sequestering agent (e.g., CO₂ sequestering agent 105 shown in FIG. 1A) is configured to absorb CO₂ and form CO₂ adduct 116.

According to some embodiments, the CO₂ adduct (e.g., CO₂ adduct 116) is dissolved in solution. In some embodiments, for example, the first electrolyte (e.g., contained within the first compartment) comprises the CO₂ adduct. For example, referring to FIG. 1B, first electrolyte 112 (e.g., contained within first compartment 108) comprises CO₂ adduct 116.

In some embodiments, as described herein in greater detail, the CO₂ adduct (e.g., CO₂ adduct 116), upon application of a stimulus, is configured to release the absorbed CO₂ and regenerate the CO₂ sequestering agent. FIG. 1C shows a schematic diagram of electrochemical cell 102 comprising CO₂ sequestering agent 105 after releasing CO₂, in accordance with certain embodiments. In some embodiments, referring to FIG. 1C, upon application of a stimulus, the CO₂ adduct (e.g., CO₂ adduct 116 shown in FIG. 1B) is configured to release the absorbed CO₂ and regenerate CO₂ sequestering agent 105. Suitable stimuli are described herein in greater detail.

In some embodiments, a fluid stream comprising the released CO₂ is configured to flow out of the electrochemical cell (e.g., via a fluid conduit). For example, referring to FIG. 1C, fluid stream 120b comprising the released CO₂ is configured to flow out of the electrochemical cell (e.g., via fluid conduit 118b).

According to certain embodiments, a system comprising an electrochemical cell is described. In some embodiments, the system comprises one or auxiliary components configured to regulate, monitor, and/or control operation of the electrochemical cell. In certain embodiments, the system comprises one or more mass flow controllers and/or meters configured to regulate the flow rate of a fluid stream entering and/or exiting the electrochemical cell. In certain embodiments, the system comprises one or more pumps (e.g., peristaltic pumps, diaphragm pumps, gear pumps, syringe pumps, etc.) configured to drive or facilitate fluid flow through the electrochemical cell. In some embodiments, the system comprises one or more CO₂ detectors and/or sensors (e.g., infrared sensors, electrochemical sensors, mass spectrometers, etc.) configured to detect, quantify, and/or monitor CO₂ in a fluid stream entering and/or exiting the electrochemical cell.

According to certain embodiments, a method of absorbing and releasing CO₂ is described. In some embodiments, a method comprises exposing a composition to a fluid stream suspected of comprising CO₂. In certain embodiments, the composition comprises a CO₂ sequestering agent. In certain embodiments, as described elsewhere herein in greater detail, the CO₂ sequestering agent comprises a NHI compound of Formula (I) and/or a metal ion-stabilized derivative thereof. Referring, for example, to FIGS. 1A-1B, a method comprises exposing a composition comprising CO₂ sequestering agent 105 (e.g., a NHI compound of Formula (I) and/or a metal ion-stabilized derivative thereof) to fluid stream 120a suspected of comprising CO₂.

The fluid stream (e.g., fluid stream 120a) may comprise any of a variety of suitable materials. In some embodiments, for example, the fluid stream comprises a gas and/or a liquid.

In certain embodiments, the fluid stream (e.g., fluid stream 120a) comprises one or more gases. In some embodiments, for example, the fluid stream comprises flue gas. As used herein, the term flue gas refers to a gaseous effluent produced by a combustion process, comprising one or more of CO₂, nitrogen, oxygen, water vapor, and optionally trace contaminants such as nitrogen oxides, sulfur oxides, particulates, and/or volatile species. In some embodiments, the fluid stream comprises air. As used herein, the term air refers to a mixture of gases comprising predominantly nitrogen and oxygen, and optionally argon, CO₂, water vapor, and trace gases. Other gaseous fluid streams are also possible, including, for example, syngas and/or natural gas fluid streams.

In certain embodiments, the fluid stream (e.g., fluid stream 120a) comprises a liquid. Suitable liquids include, for example, non-aqueous liquids, aqueous liquids (e.g., water), and/or combinations thereof. In some embodiments, the CO₂ is dissolved in the liquid.

According to some embodiments, the method comprises absorbing the CO₂, if present, from the fluid stream. Referring, for example, to FIGS. 1A-1B, the method comprises absorbing the CO₂, if present, from fluid stream 120a. In certain embodiments, absorbing the CO₂ from the fluid stream comprises reacting the CO₂ sequestering agent (e.g., the NHI compound of Formula (I) and/or the metal ion-stabilized derivative thereof) and the CO₂ to form a CO₂ adduct. For example, referring to FIG. 1B, absorbing the CO₂, if present, from fluid stream 120a comprises reacting CO₂ sequestering agent 105 and the CO₂ to form CO₂ adduct 116. In certain embodiments, as described herein in greater detail, the CO₂ adduct comprises a reaction product between CO₂ and the NHI compound of Formula (I) and/or the metal ion-stabilized derivative thereof.

The reaction enthalpy of the CO₂ sequestering agent (e.g., the NHI compound of Formula (I) and/or the metal ion-stabilized derivative thereof) and the CO₂ may be any of a variety of suitable values. In certain embodiments, the reaction enthalpy of the CO₂ sequestering agent and the CO₂ refers to the amount of heat release after absorption of CO₂ by the CO₂ sequestering agent. In some embodiments, for example the reaction enthalpy of the CO₂ sequestering agent and the CO₂ is less than 0 kJ/mol of CO₂, less than or equal to −50 k/mol of CO₂, less than or equal to −75 kJ/mol of CO₂, or less than or equal to −100 kJ/mol of CO₂. In some embodiments, the reaction enthalpy of the CO₂ sequestering agent and the CO₂ is greater than or equal to −150 kJ/mol of CO₂, greater than or equal to −125 kJ/mol of CO₂, greater than or equal to −100 kJ/mol of CO₂, or greater than or equal to −75 kJ/mol of CO₂. Combinations of the above recited ranges are possible (e.g., the reaction enthalpy of the CO₂ sequestering agent and the CO₂ is less than 0 kJ/mol of CO₂ and greater than or equal to −150 kJ/mol CO₂).

According to certain embodiments, the reaction enthalpy of the CO₂ sequestering agent and the CO₂ is determined using a micro reaction calorimeter.

Any of a variety of suitable amounts of CO₂ may be absorbed by the CO₂ sequestering agent (e.g., the NHI compound of Formula (I) and/or the metal ion-stabilized derivative thereof). In certain embodiments, for example, greater than or equal to 0.1 mol of CO₂, greater than or equal to 0.5 mol of CO₂, greater than or equal to 0.8 mol of CO₂, greater than or equal to 1 mol of CO₂, greater than or equal to 1.2 mol of CO₂, greater than or equal to 1.4 mol of CO₂, greater than or equal to 1.6 mol of CO₂, greater than or equal to 1.8 mol of CO₂, or greater than or equal to 2 mol of CO₂ is absorbed per mol of the CO₂ sequestering agent. In certain embodiments, less than or equal to 2.5 mol of CO₂, less than or equal to 2 mol of CO₂, less than or equal to 1.8 mol of CO₂, less than or equal to 1.6 mol of CO₂, less than or equal to 1.4 mol of CO₂, less than or equal to 1.2 mol of CO₂, less than or equal to 1 mol of CO₂, less than or equal to 0.8 mol of CO₂, or less than or equal to 0.5 mol of CO₂ is absorbed per mol of the CO₂ sequestering agent. Combinations of the above recited ranges are also possible (e.g., greater than or equal to 0.1 mol of CO₂ and less than or equal to 2.5 mol of CO₂ is absorbed per mol of the CO₂ sequestering agent). Other ranges are also possible.

According to certain embodiments, the method comprises applying a stimulus to release the CO₂ from the CO₂ adduct and regenerate the CO₂ sequestering agent (e.g., the NHI compound of Formula (I) and/or the metal ion-stabilized derivative thereof). Referring, for example, to FIGS. 1B-1C, the method comprises applying a stimulus to release CO₂ from CO₂ adduct 116 and regenerate CO₂ sequestering agent 105.

The stimulus may be any of a variety of stimuli. In certain embodiments, for example, the stimulus is an electrical potential. Referring, for example, to FIG. 1C, the method comprises applying electrical potential 124 to release CO₂ from CO₂ adduct 116 and regenerate CO₂ sequestering agent 105. In some embodiments, the electrical potential adjusts a redox state of the CO₂ adduct to release CO₂ from the CO₂ adduct. In certain embodiments, for example, the electrical potential oxidizes a redox-active moiety of the CO₂ adduct to release CO₂ from the CO₂ adduct (e.g., at an anode). For example, referring to FIG. 1C, electrical potential 124 oxidizes a redox-active moiety of CO₂ adduct 116 to release CO₂ from CO₂ adduct 116 at first electrode 104 (e.g., anode), thereby generating an oxidized CO₂ sequestering agent (e.g., a CO₂ sequestering agent comprising an oxidized redox-active moiety). In some embodiments, the electrical potential reduces the oxidized CO₂ sequestering agent to regenerate the CO₂ sequestering agent (e.g., at a cathode). Referring, for example, to FIG. 1C, electrical potential 124 reduces the oxidized CO₂ sequestering agent to regenerate CO₂ sequestering agent 105 at second electrode 106 (e.g., cathode).

The CO₂ sequestering agent (e.g., the NHI compound of Formula (I) and/or the metal ion-stabilized derivative thereof) may have any of a variety of suitable redox potentials. In certain embodiments, for example, the CO₂ sequestering agent has a redox potential greater than or equal to −1 V, greater than or equal to −0.9 V, greater than or equal to −0.8 V, greater than or equal to −0.7 V, greater than or equal to −0.6 V, greater than or equal to −0.5 V, greater than or equal to −0.4 V, greater than or equal to −0.3 V vs Fc⁺/Fc, greater than or equal to −0.2 V, greater than or equal to −0.1 V, greater than or equal to 0 V, greater than or equal to 0.1 V, greater than or equal to 0.2 V, greater than or equal to 0.3 V, or greater than or equal to 0.4 V vs Fc⁺/Fc. In some embodiments, the CO₂ sequestering agent has a redox potential less than or equal to 0.5 V, less than or equal to 0.4 V, less than or equal to 0.3 V, less than or equal to 0.2 V, less than or equal to 0.1 V, less than or equal to 0 V, less than or equal to −0.1 V, less than or equal to −0.2 V, less than or equal to −0.3 V, less than or equal to −0.4 V, less than or equal to −0.5 V, less than or equal to −0.6 V, less than or equal to −0.7 V, less than or equal to −0.8 V, or less than or equal to −0.9 V vs Fc⁺/Fc. Combinations of the above recited ranges are possible (e.g., the CO₂ sequestering agent has a redox potential greater than or equal to −1 V and less than or equal to 0.5 V vs Fc⁺/Fc). Other ranges are also possible.

According to some embodiments, a reduction potential of the CO₂ sequestering agent (e.g., the NHI compound of Formula (I) and/or the metal ion-stabilized derivative thereof) is greater than an oxygen reduction potential measured under the same conditions. In certain embodiments, the CO₂ sequestering agent (e.g., the NHI compound of Formula (I) and/or the metal ion-stabilized derivative thereof) advantageously avoids oxygen reduction reactions, thereby reducing or preventing formation of undesired oxygen-reduction byproducts (e.g., superoxide, peroxide, or other reactive oxygen species), improving Faradaic efficiency, minimizing parasitic charge consumption, and enhancing stability and durability of the system.

In some embodiments, the reduction potential of the CO₂ sequestering agent (e.g., the NHI compound of Formula (I) and/or the metal ion-stabilized derivative) thereof is at least 100 mV greater, at least 150 mV greater, at least 200 mV greater, at least 250 mV greater, at least 300 mV greater, at least 400 mV greater, at least 450 mV greater, or at least 500 mV greater than the oxygen reduction potential measured under the same conditions. In certain embodiments, the reduction potential of the CO₂ sequestering agent (e.g., the NHI compound of Formula (I) and/or the metal ion-stabilized derivative) thereof is less than or equal to 500 mV greater, less than or equal to 450 mV greater, less than or equal to 400 mV greater, less than or equal to 350 mV greater, less than or equal to 300 mV greater, less than or equal to 250 mV greater, less than or equal to 200 mV greater, or less than or equal to 150 mV greater than the oxygen reduction potential measured under the same conditions. Combinations of the above recited ranges are possible (e.g., the reduction potential of the CO₂ sequestering agent is at least 100 mV greater than and less than or equal to 500 mV greater than the oxygen reduction potential measured under the same conditions). Other ranges are also possible.

According to some embodiments, the electrochemical CO₂ absorption and release process exhibits an advantageously low energy consumption. In certain embodiments, for example, the energy consumption of the electrochemical CO₂ absorption and release process is less than or equal to 50 kJ/mol CO₂, less than or equal to 40 kJ/mol CO₂, less than or equal to 30 kJ/mol CO₂, less than or equal to 20 kJ/mol CO₂, less than or equal to 15 kJ/mol CO₂, less than or equal to 10 kJ/mol CO₂, less than or equal to 5 kJ/mol CO₂, less than or equal to 2 kJ/mol CO₂, or less. In some embodiments, the energy consumption of the electrochemical CO₂ absorption and release process is greater than or equal to 1 kJ/mol CO₂, greater than or equal to 2 kJ/mol CO₂, greater than or equal to 5 kJ/mol CO₂, greater than or equal to 10 kJ/mol CO₂, greater than or equal to 20 kJ/mol CO₂, greater than or equal to 30 kJ/mol CO₂, or greater than or equal to 40 ki/mol CO₂. Combinations of the above recited ranges are possible (e.g., the energy consumption of the electrochemical CO₂ absorption and release process is less than or equal to 50 kJ/mol CO₂ and greater than or equal to 1 kJ/mol CO₂). Other ranges are also possible.

In some embodiments, the energy consumption or the electrochemical CO₂ absorption and release process is determined under operating conditions in which the electrochemical cell is a flow cell. In certain embodiments, for example, the energy consumption of the electrochemical CO₂ absorption and release process in a flow cell is less than or equal to 50 kJ/mol CO₂, less than or equal to 40 kJ/mol CO₂, or less than or equal to 30 kJ/mol CO₂. In some embodiments, the energy consumption of the electrochemical CO₂ absorption and release process in a flow cell is greater than or equal to 20 kJ/mol CO₂, greater than or equal to 30 kJ/mol CO₂, or greater than or equal to 40 kJ/mol CO₂, or less. Combinations of the above recited ranges are possible (e.g., the energy consumption of the electrochemical CO₂ absorption and release process in a flow cell is less than or equal to 50 kJ/mol CO₂ and greater than or equal to 20 kJ/mol CO₂). Other ranges are also possible.

According to certain embodiments, the energy consumption of the electrochemical CO₂ absorption and release process is calculated as the net electrical energy input during a reduction and oxidation cycle divided by the total amount of CO₂ captured and released during the cycle.

In some embodiments, the stimulus is a salt exchange process. For example, in some embodiments, the absorption of CO₂ by the CO₂ sequestering agent can be influenced by the relative Lewis acidity of cations present in a solution comprising the CO₂ sequestering agent. In certain embodiments, cations exhibiting a high Lewis acidity promote absorption of CO₂ by the CO₂ sequestering agent, for example, through increased Coulombic stabilization. In certain embodiments, the release of CO₂ from the CO₂ adduct can be influenced by the relative Lewis acidity of cations present in a solution comprising the CO₂ adduct. In some embodiments, cations exhibiting a low Lewis acidity promote release of CO₂ from the CO₂ adduct.

In certain embodiments, the electrochemical cell is an asymmetric electrochemical cell comprising a first electrode configured to store a strong Lewis-acidic cation and a second electrode configured to store a weak Lewis-acidic cation. Referring, for example, to FIGS. 1A-1C, electrochemical cell 102 is an asymmetric electrochemical cell comprising first electrode 104 configured to store a strong Lewis-acidic cation and second electrode 106 configured to store a weak Lewis-acidic cation.

The strong Lewis-acidic cation may be any of a variety of suitable species. In certain embodiments, for example, the strong Lewis-acidic cation comprises lithium (Li), calcium (Ca²⁺), magnesium (Mg²⁺), zinc (Zn²⁺), and/or other divalent cations. Other strong Lewis-acidic cations are also possible.

The weak Lewis-acidic cation may be any of a variety of suitable species. In some embodiments, for example, the weak Lewis-acidic cation comprises potassium (K⁺), cesium (Cs⁺), and/or tetrabutylammonium (TBA⁺). Other weak Lewis-acidic cations are also possible.

In certain embodiments, strong Lewis-acidic cations are present in an electrolyte solution comprising the CO₂ sequestering agent prior to or independently of any applied electrochemical potential. In some embodiments, the strong Lewis-acidic cations promote absorption of CO₂ by the CO₂ sequestering agent. For example, referring to FIGS. 1A-1B, strong Lewis-acidic cations present in first electrolyte 112 may promote absorption of CO₂ by CO₂ sequestering agent 105 and formation of CO₂ adduct 116.

In some embodiments, upon application of an electrochemical potential in a first direction, strong Lewis-acidic cations are released from the first electrode into the first electrolyte, thereby promoting absorption of CO₂ by the CO₂ sequestering agent. For example, referring to FIGS. 1A-1B, upon application of an electrochemical potential in a first direction (not shown in FIGS. 1A-1B), strong Lewis-acidic cations are released from first electrode 104 into first electrolyte 112, thereby promoting absorption of CO₂ by CO₂ sequestering agent 105 and formation of CO₂ adduct 116.

In some embodiments, upon application of an electrochemical potential in a first direction, weak Lewis-acidic cations are absorbed from the second electrolyte by the second electrode, thereby promoting absorption of CO₂ by the CO₂ sequestering agent. Referring, for example, to FIGS. 1A-1B, upon application of an electrochemical potential in a first direction (not shown in FIGS. 1A-1B), weak Lewis-acidic cations are absorbed from second electrolyte 114 by second electrode 106, thereby promoting absorption of CO₂ by CO₂ sequestering agent 105 and formation of CO₂ adduct 116.

In certain embodiments, upon application of an electrochemical potential in a second direction opposite than the first direction, weak Lewis-acidic cations are released from the second electrode into the second electrolyte (and into the first electrolyte via a separator), thereby promoting release of CO₂ from the CO₂ adduct. Referring, for example, to FIGS. 1B-1C, upon application of electrochemical potential 124 in a second direction opposite than the first direction, weak Lewis-acidic cations are released from second electrode 106 into second electrolyte 114 (and into first electrolyte 112 via separator 122), thereby promoting release of CO₂ from CO₂ adduct 116 and regeneration of CO₂ sequestering agent 105.

According to some embodiments, upon application of an electrochemical potential in a second direction opposite than the first direction, strong Lewis-acidic cations are absorbed from the first electrolyte by the first electrode, thereby promoting release of CO₂ from the CO₂ adduct. For example, referring to FIGS. 1B-1C, upon application of electrochemical potential 124 in a second direction opposite than the first direction, strong Lewis-acidic cations are absorbed from first electrolyte 112 by first electrode 104, thereby promoting release of CO₂ from CO₂ adduct 116 and regeneration of CO₂ sequestering agent 105.

According to certain embodiments, the salt exchange process does not adjust a redox state of the CO₂ sequestering agent.

Any of a variety of suitable amounts of CO₂ may be released from the CO₂ adduct and/or the metal ion-stabilized derivative thereof (e.g., upon application of the stimulus). In certain embodiments, for example, greater than or equal to 0.1 mol of CO₂, greater than or equal to 0.5 mol of CO₂, greater than or equal to 0.8 mol of CO₂, greater than or equal to 1 mol of CO₂, greater than or equal to 1.2 mol of CO₂, greater than or equal to 1.4 mol of CO₂, greater than or equal to 1.6 mol of CO₂, greater than or equal to 1.8 mol of CO₂, or greater than or equal to 2 mol of CO₂ is released from the CO₂ adduct and/or the metal ion-stabilized derivative thereof. In certain embodiments, less than or equal to 2.5 mol of CO₂, less than or equal to 2 mol of CO₂, less than or equal to 1.8 mol of CO₂, less than or equal to 1.6 mol of CO₂, less than or equal to 1.4 mol of CO₂, less than or equal to 1.2 mol of CO₂, less than or equal to 1 mol of CO₂, less than or equal to 0.8 mol of CO₂, or less than or equal to 0.5 mol of CO₂ is released from the CO₂ adduct and/or the metal ion-stabilized derivative thereof. Combinations of the above recited ranges are also possible (e.g., greater than or equal to 0.1 mol of CO₂ and less than or equal to 2.5 mol of CO₂ is released from the CO₂ adduct and/or the metal ion-stabilized derivative thereof). Other ranges are also possible.

According to some embodiments, the amount of CO₂ released from the CO₂ adduct may be equivalent to the amount of CO₂ absorbed by the CO₂ sequestering agent (e.g., the NHI compound of Formula (I) and/or the metal ion-stabilized derivative thereof).

According to some embodiments, because the CO₂ sequestering agent is regenerated following release of the CO₂, the absorption and release of CO₂ may advantageously be performed in a repeating manner. In some embodiments, for example, a cycle comprising absorbing the CO₂, if present, from the fluid stream and applying the stimulus to release the CO₂ from the CO₂ adduct and regenerate the CO₂ sequestering agent (e.g., the NHI compound of Formula (I) and/or the metal ion-stabilized derivative thereof) is performed greater than or equal to 2 times, greater than or equal to 5 times, greater than or equal to 10 times, greater than or equal to 20 times, greater than or equal to 30 times, greater than or equal to 40 times, greater than or equal to 50 times, greater than or equal to 100 times, greater than or equal to 500 times, or more. In certain embodiments, the cycle is performed less than or equal to 1,000 times, less than or equal to 500 times, less than or equal to 100 times, less than or equal to 50 times, less than or equal to 40 times, less than or equal to 30 times, less than or equal to 20 times, less than or equal to 10 times, or less than or equal to 5 times. Combinations of the above recited ranges are possible (e.g., the cycle is performed greater than or equal to 2 times and less than or equal to 1,000 times). Other ranges are also possible.

In some embodiments, the method comprises flowing a fluid stream comprising the released CO₂ out of the electrochemical cell (e.g., via a fluid conduit). For example, referring to FIG. 1C, the method comprises flowing fluid stream 120b comprising the released CO₂ out of the electrochemical cell (e.g., via fluid conduit 118b). In some embodiments, the method comprises detecting the released CO₂ (e.g., using a CO₂ detector and/or sensor). In certain embodiments, the method comprises detecting a presence and/or an amount of the released CO₂ (e.g., using a CO₂ detector and/or sensor).

The compositions, articles, systems, and/or methods described herein may be used in any of a variety of suitable industrial and/or environmental applications. In some embodiments, the compositions, articles, systems, and/or methods may be used for removing CO₂ from point-source emission streams (e.g., flue gas, syngas, or natural gas), for direct air capture of ambient CO₂, for purification or enrichment of CO₂-containing gas mixtures, and/or for supplying controlled quantities of CO₂ to downstream processes such as chemical synthesis, carbonation, fermentation, and/or geologic sequestration. In certain embodiments, the compositions, articles, systems, and/or methods are advantageously configured to operate in repeated capture-release cycles, thereby enabling low-energy regeneration of the CO₂ sequestering agent.

U.S. Provisional Patent Application No. 63/737,590, filed Dec. 20, 2024, and entitled “Compositions, Articles, and Methods Related to Redox-Active Sorbents for Electrochemical Carbon Dioxide Separation,” is incorporated herein by reference in its entirety for all purposes.

The following disclosure is directed to examples intended to illustrate certain embodiments of the present disclosure related compositions, systems, and methods of absorbing and releasing CO₂. It does not necessarily exemplify the full scope of the disclosure.

The synthesis and application of a family of sorbent molecules for CO₂ capture with an electrochemical oxidation process used to achieve CO₂ release and sorbent regeneration is described. Unlike conventional electrochemical capture paradigms based on electrochemically activated quinones, the disclosed chemistry has a more positive redox potential to that of O₂ from air, which can afford higher selectivity and impart air stability, therein addressing the major challenges associated with quinone chemistry. The successful synthesis, physicochemical characterization of CO₂ binding, and reduction to practice of the chemical capture/electrochemical release process for a representative subset of reactants is demonstrated. Also demonstrated is how the CO₂ binding strength and redox potential and reversibility can be tailored at the molecular scale by altering the interactions of the CO₂-loaded sorbent with the supporting electrolyte. It is further demonstrated that the sorbent molecules with similar reaction enthalpy as conventional amine sorbents have faster CO₂ capture kinetics and achievable CO₂ loading. The disclosed sorbents and electrochemical process may be applied to concentrated CO₂ emission mitigation and in direct-air capture processes.

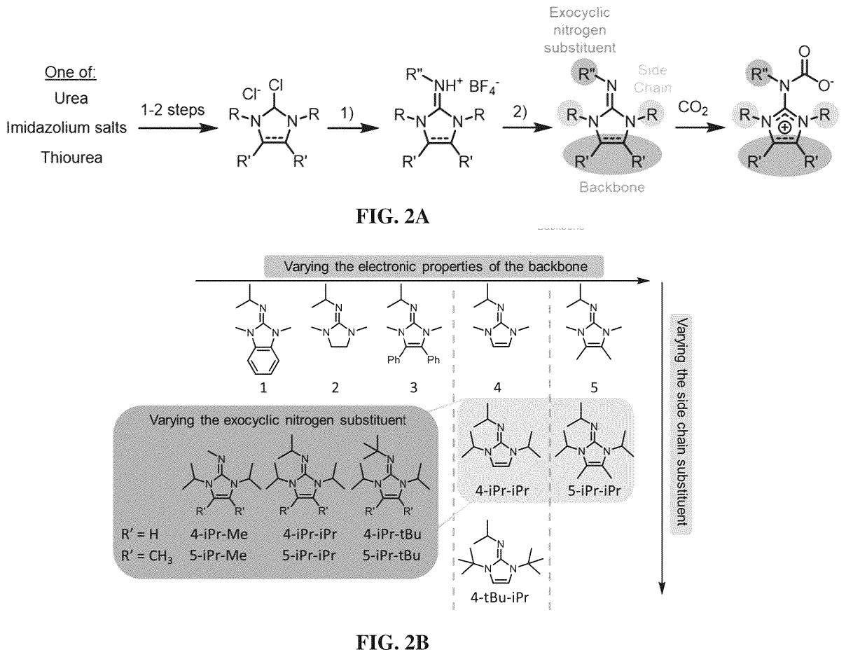

As shown in FIG. 2A, a series of 2-chloroazolium salts were synthesized with various functional groups on three main N-heterocyclic (NHI) positions, which are the backbone, side chain, and exocyclic nitrogen. The 2-chloroazolium salts were then reacted with an amine of interest in acetonitrile and the products were deprotonated with KOtBu in THF to obtain the final NHI. A carbon dioxide adduct is shown in the last reaction of FIG. 2A. In some embodiments, the CO₂ binding site on NHI is on the exocyclic nitrogen position. In certain embodiments, the CO₂ binding site on NHI is on the R″ group on the exocyclic nitrogen position.

FIG. 2B shows various NHIs described herein. NHI was investigated with 5 different backbones numbered from 1 to 5, fixing the methyl (Me) group on the side chain and isopropyl (iPr) group on the exocyclic nitrogen. NHIs with backbones 4 and 5 were further selected to systematically vary their side chain and the exocyclic functional groups. These functional groups were chosen to be methyl (Me), isopropyl (iPr), and tert-butyl (tBu), aiming to elucidate the steric hindrance effects on NHI CO₂ capture performances.

The nomenclatures of NHIs described herein are detailed in FIG. 2B. The Arabic number is used to differentiate different backbone structures (e.g., 1, 2, etc.). For NHIs with the same backbone structure but different side chain and exocyclic nitrogen functional groups, two abbreviations of the functional groups (e.g. Me, iPr, and tBu) are followed with the order of side chain and then exocyclic nitrogen.

The reaction enthalpy of NHIs and CO₂ (ΔH_{NHI-CO2}), also called CO₂ adsorption heat of NHI, is a direct measure of the heat release after NHI-CO₂ binding, which provides thermodynamics information of the stability of the NHI-CO₂ adduct and the strength of the binding. Therefore, after the synthesis and characterization of NHIs, a micro reaction calorimeter (uRc) equipped with the gas flow option was employed to measure the ΔH_{NHI-CO2}. The initial testing was conducted with the conditions of 0.1 M NHI in DMSO with 100% CO₂ gas flow.

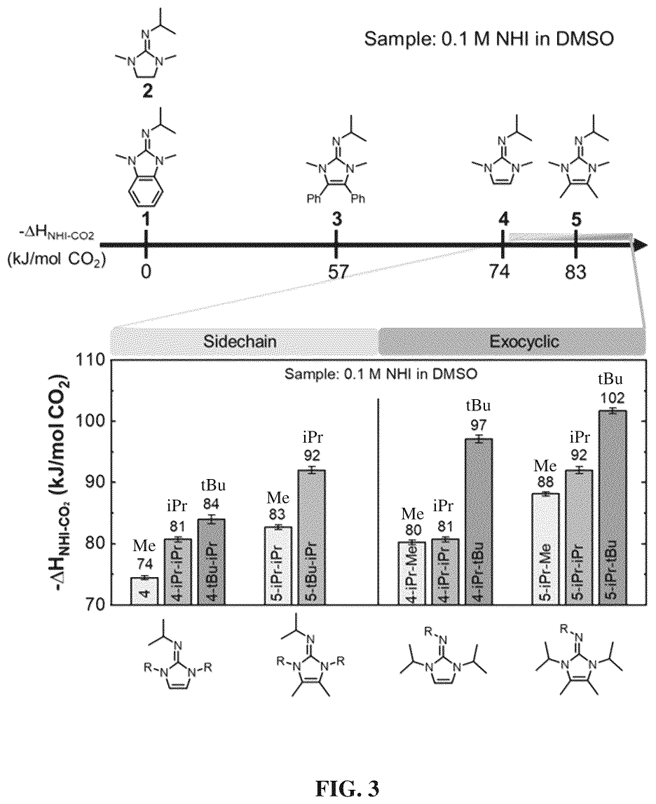

FIG. 3 (top) shows the ΔH_{NHI-CO2} for NHIs with different backbone electronic structures. The ΔH_{NHI-CO2} of NHI with saturated (1) and benzene (2) backbones were measured to be 0 kJ/mol CO₂, indicating these NHIs do not bind with CO₂, whereas NHIs with the unsaturated backbone (3, 4, and 5) demonstrate a wide range of ΔH_{NHI-CO2} from −50 to −83 kJ/mol. This result provides evidence that the electronics properties of the backbones have influences on the reaction enthalpy of NHI with CO₂, and the additional n electrons on the unsaturated backbones provide enough nucleophilicity of NHIs toward binding CO₂. Furthermore, with the unsaturated backbone, the ΔH_{NHI-CO2} can be further tuned by adding additional electron withdrawing (-Ph, ΔH_{NHI-CO2}=−50 kJ/mol) or electron donating groups (-Me. ΔH_{NHI-CO2}=−83 kJ/mol) on the backbone.

Subsequently, the backbones 4 and 5 were selected and fixed, and the functional groups on the sidechain and the exocyclic nitrogen were varied to investigate the effect of steric hindrances on NHI-CO₂ capture properties, as shown in FIG. 3 (bottom). Interestingly, the measured ΔH_{NHI-CO2} turned more negative as the steric hindrance on NHIs was increased from Me to iPr and tBu on the side chain and/or the exocyclic nitrogen positions, indicating an increase of the energy release when NHIs with larger steric repulsion react with CO₂.

It is believed that the increase of the steric hindrance will increase the intramolecular steric repulsion and destabilize the lean NHI, as the C═N double bond between quaternary carbon and exocyclic nitrogen is not able to rotate. However, as CO₂ reacts with NHI, this un-rotatable bond is turned into a rotatable C—N single bond, releasing the steric repulsion of the molecules. Therefore, a more steric hindered NHI could release more energy after reacting with CO₂, leading to a more negative ΔH_{NHI-CO2}.

In addition to the reaction enthalpy, another engineering parameter for CO₂ sorbent is the maximum achievable CO₂ loading. In conventional amine scrubbing process, amine concentrations are typically in the magnitude of molar (e.g. 6-7 M for 30 wt % MEA). Therefore, the CO₂ loading of NHI was tested at a concentration of 1 M in DMI (1,3-dimethyl-2-imidazolidinone) and compared to aqueous amines (MEA and DEA) of the same concentration as a reference. Three representative NHIs (4, ΔH_{NHI-CO2}=−74 kJ/mol CO₂; 4-iPr-iPr. ΔH_{NHI-CO2}=−81 kJ/mol CO₂; 5-iPr-iPr, ΔH_{NHI-CO2}=−92 kJ/mol CO₂) were selected. These NHIs span a wide but uniform range of the ΔH_{NHI-CO2} that allows for the examination of NHIs with moderate to strong binding with CO₂.

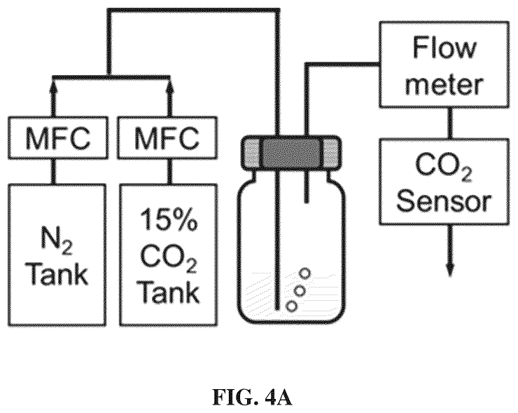

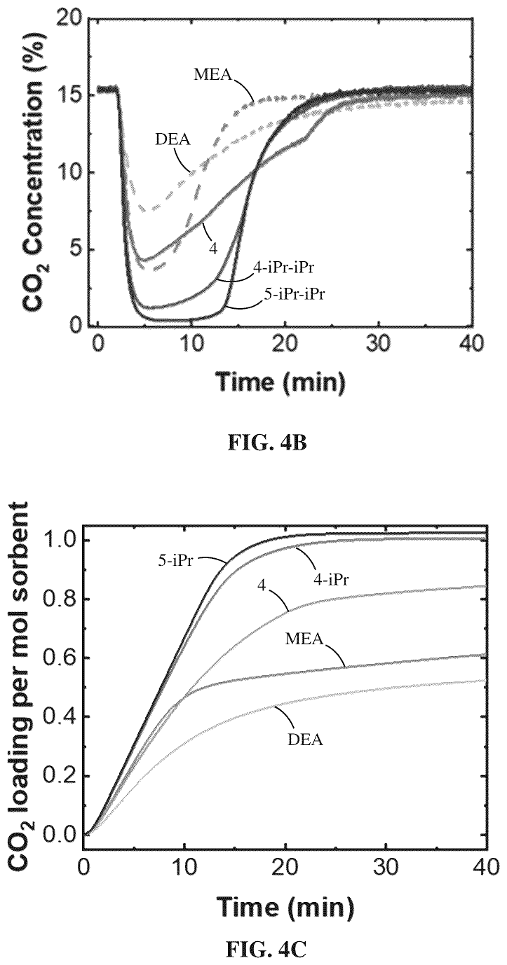

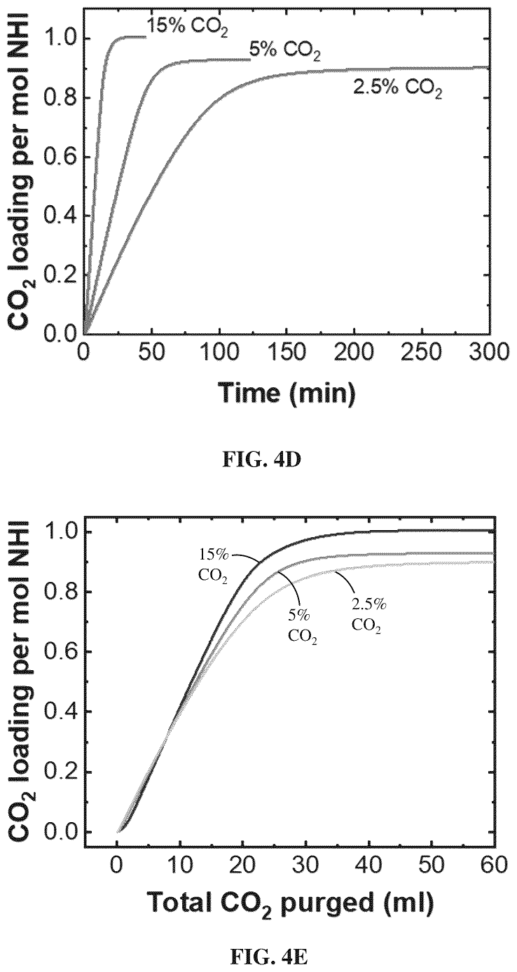

FIG. 4A shows an experimental setup for measuring the CO₂ loading of the sorbents. Two mass flow controllers were used to control the flow rate of N₂ and 15% CO₂ (balance N₂), and the mixed gas was sent to a gas-tight vial to purge the sample. The outlet of the vial was connected to a flow meter (to measure the outlet gas flow rate) and then a CO₂ sensor (to measure the outlet CO₂ concentration). The combined signals from the flow meter and CO₂ sensor provided information of the total outlet CO₂ flow rate.

FIG. 4B plots the CO₂ concentration versus time when 15% CO₂ is purged to each sorbent. A decrease of the CO₂ concentration within the curve during testing indicates the CO₂ in the gas mixture gets scrubbed by the sorbent. Note that the degree of CO₂ concentration reduction also correlates to the CO₂ capture rate of the NHI sorbent since more CO₂ is captured at a given time if the outlet CO₂ concentration is lower. From the results, it can be observed that 5-iPr-iPr, which has the most negative ΔH_{NHI-CO2}, effectively reduced the outlet CO₂ concentration from 15% to 0.4% (the lowest concentration in the curve) compared to 4-iPr-iPr (1.2%) and 4 (4.3%). Therefore, the CO₂ capture rates are in the increase order of 4, 4-iPr-iPr. and 5-iPr-iPr. Based on the result, a more negative ΔH_{NHI-CO2} correlates to better CO₂ capture rates, and a larger performance difference was observed when reducing the ΔH_{NHI-CO2} from −81 to −74 kJ/mol CO₂ (4-iPr-iPr vs. 4) compared to from −92 to −81 kJ/mol CO₂ (5-iPr-iPr vs. 4-iPr-iPr). However, if comparing 4 and 4-iPr-iPr to conventional DEA and MEA, which have similar reaction enthalpy with CO₂ (DEA: −74 kJ/mol CO₂ and MEA: −85 kJ/mol CO₂). NHIs still outperform the amines in terms of the CO₂ capture rate.

Integrating the amount of captured CO₂ along time, the increase of the CO₂ loading over time for various sorbents is plotted in FIG. 4C. The CO₂ loadings of NHIs increased in the first 20 minutes and then plateaued to reach its maximum loading. At the end of the testing, samples of 4, 4-iPr-iPr, and 5-iPr-iPr reached the CO₂ loading of 0.85, 1.00, 1.02 mol CO₂/mol sorbent, respectively, showing an achievable CO₂ loading at industrial operation conditions. Note that there is a background amount of CO₂ dissolved in DMI, which was determined to be 0.03 mol CO₂/mol sorbent for 1 M sample. In addition to the final CO₂ loading, the slope of each curve in the early time of the measurement (0-10 minutes) also indicated the initial CO₂ capture rate for each sorbent. It was shown that 5-iPr-iPr and 4-iPr-iPr have superior CO₂ capture rates compared to MEA and DEA.

In addition to 15% CO₂, 4-iPr-iPr, which has a comparable performance as 5-iPr-iPr but is easier to synthesize, was also selected to examine its achievable CO₂ loading with 5% and 2.5% CO₂. As shown in FIG. 4D, the achievable CO₂ loading for 4-iPr-iPr only dropped slightly from 1.00 to 0.93 and 0.90 mol CO₂/mol sorbent for 5% and 2.5% CO₂, respectively. This result suggests that even at much lower CO₂ concentration, NHI with suitable CO₂ reaction enthalpy still maintains decent capture capacity. Lastly, the x-axis of FIG. 4D was normalized to the total CO₂ purged to the sample (FIG. 4E) using the gas flow rate, corresponding CO₂ concentration, and time, to examine the effect of the CO₂ concentration on the CO₂ capture rate for 4-iPr-iPr. Since the initial slope of each curve remain similar, it was concluded that the available CO₂ at a given time is the rate limiting factor for the CO₂ captured rate.

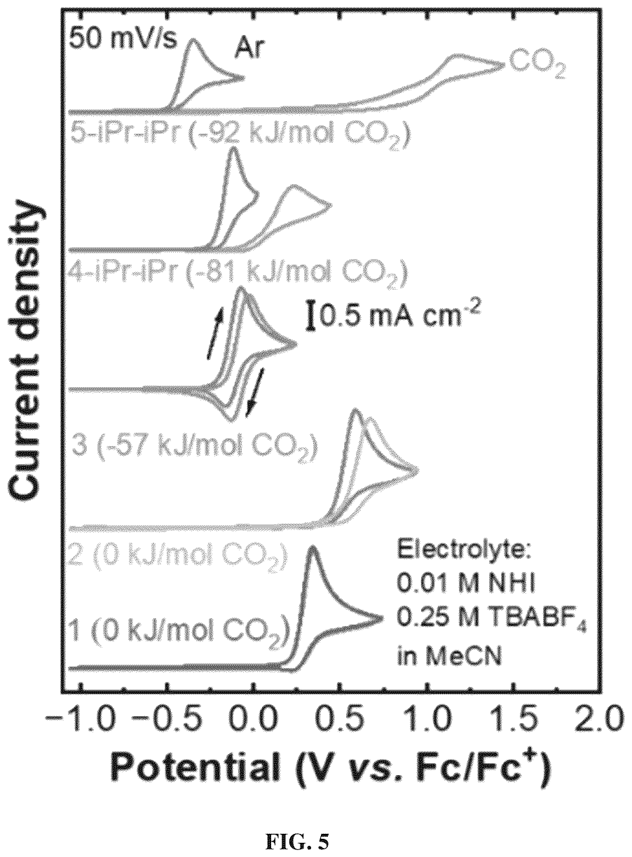

The tested NHIs demonstrated excellent thermochemical properties as CO₂ sorbent materials. After capturing CO₂, an application in electrochemical CO₂ redox sorbent was investigated. Therefore, CVs of various NHIs (1, 2, 3, 4-iPr-iPr, and 5-iPr-iPr) were conducted both under Ar and CO₂ atmosphere and compared in FIG. 5.

By varying the backbones, similar CV responses were observed with some peak potential shifts. The similar responses indicated the redox active site is the exocyclic nitrogen since this is the only moiety that is the same across various NHLs.

For NHIs that bind to CO₂ (e.g., 3, 4-iPr-iPr, and 5-iPr-iPr), it was observed that NHI with more negative ΔH_{NHI-CO2} (stronger binding) has a more negative oxidation peak potential, indicating it is easier to oxidize. A rational explanation for this phenomenon is that NHI with more negative ΔH_{NHI-CO2} has a higher electron density on the exocyclic nitrogen site for CO₂ binding, allowing an easier oxidation of the molecule.

Under CO₂ atmosphere, the oxidation potentials of NHI-CO₂ shifted positively compared to their corresponding Ar case, especially for NHIs that bind with CO₂ strongly (4-iPr-iPr and 5-iPr-iPr). The positive shift of the potential indicates that more oxidative potentials oxidize NHI-CO₂ adduct. This result is in accordance with expectations since the reaction between NHI and CO₂ can be considered as the oxidation of the original NHI, reducing its electron density and making it harder to oxidize further.

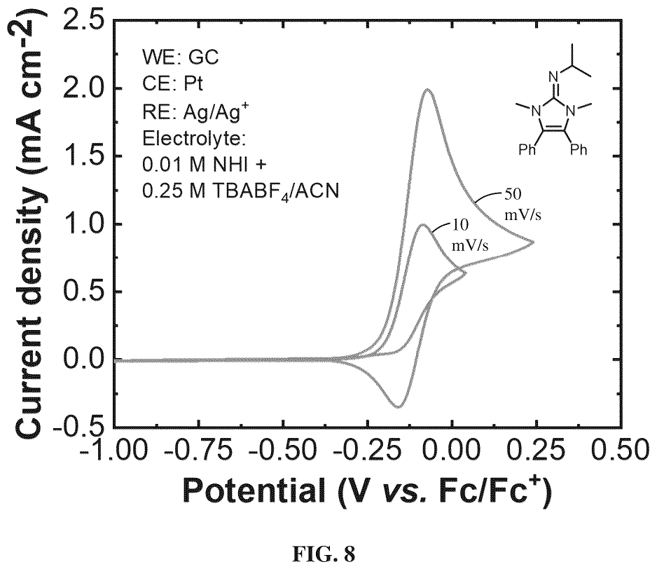

The oxidation of various NHLs was non-reversible under both Ar and CO₂ cases. This indicated a chemical side reaction happening to the oxidized NHI, preventing it from being reduced back. The irreversibility was universal across various NHIs studied herein with the only exception being 3, which showed reasonable reduction current. However, if the scan rate was slowed down to 10 mV/s, as shown in FIG. 8, the reductive current fully disappeared. Therefore, it was concluded that the reversibility observed in 3 was attributed to the slower chemical side reaction rate.

Full oxidation of the NHI was attempted using a H-cell setup and 4-iPr-iPr as a model NHI to probe the NHI oxidation product. The term “NHI” will be used below to refer to 4-iPr-iPr for simplicity. Note that the NHI oxidation product here refers to the final compound that formed after the electrochemical oxidation and the subsequent unknown chemical side reaction. The potential during the oxidation is controlled to be lower than 0.0 V vs. Fc/Fc⁺ to conduct the exact oxidation reaction observed in FIG. 5.

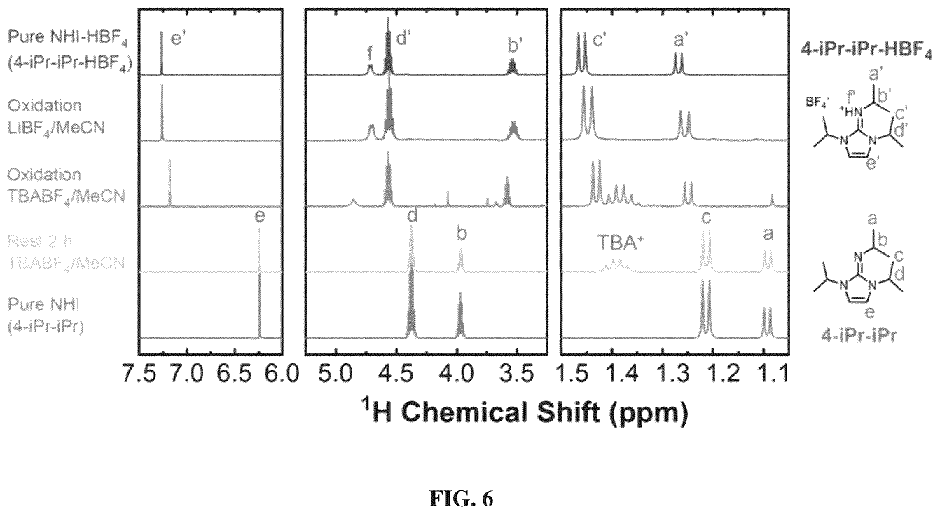

Firstly, it was confirmed that the NHI is stable after resting it in 0.25 M TBABF₄/MeCN, which was the same electrolyte used in CV analysis, without passing charge for 2 hours. As shown in FIG. 6, the resting sample presented the exact same ¹H-NMR spectra as the pure NHI.

Oxidation charge (1 electron per NHI) was then passed to oxidize the NHI in TBABF₄/MeCN electrolyte and then ¹H-NMR was taken to examine the final species formed. It was observed that the peaks shifted from NHI to NHI-HBF₄ and there was an emergence of “f” peak, indicating the protonation on the exocyclic nitrogen. Note that the resulting peaks did not fully align with the pure NHI-HBF₄ peak attributed to the following reasons. The oxidation charge did not fully oxidize NHI, so the final product was a mixture of NHI and NHI-HBF₄. Since the proton on the exocyclic nitrogen of NHI-HBF₄ is labile and exchangeable, the final peak shifts are therefore between NHI and NHI-HBF₄.

Based on this observation, it was proposed that after initial electro-oxidation, the exocyclic NHI loses an electron to become a radical cation. This radical cation is unstable in the electrolyte, so a hydrogen abstraction reaction happens and NHI-HBF₄ is then formed.

With this proposed reaction scheme, a further confirmation of the hydrogen source can provide a guideline of suppressing this unwanted side reaction. The potential hydrogen source in the electrolyte could be residual water. TBA cation, and MeCN solvent. Residual water was ruled out since the water content of the electrolyte is less than 20 ppm. Therefore, there was not enough water from the mass balance perspective to protonate the NHI. To rule out the TBA cation, LiBF₄ was used as the electrolyte salt to perform the same electrochemical oxidation experiment. The resulting ¹H-NMR spectra showed the exact same result as that in TBABF₄/MeCN electrolyte, supporting the claim that MeCN is the hydrogen source to proton abstraction.

Overall, the experimental results suggested that solvent optimizations could mitigate the proton abstraction from the solvent after NHI oxidation, allowing reversible NHI redox reaction.

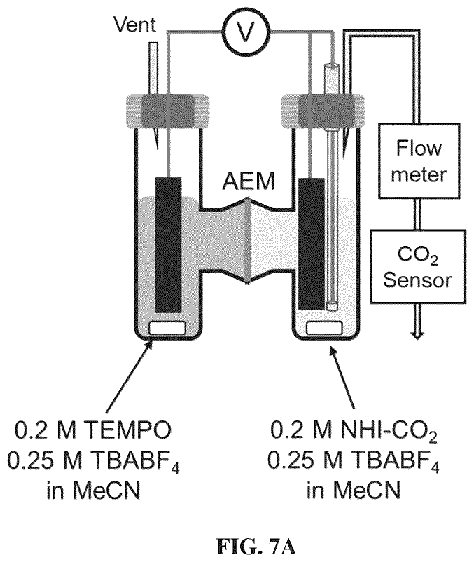

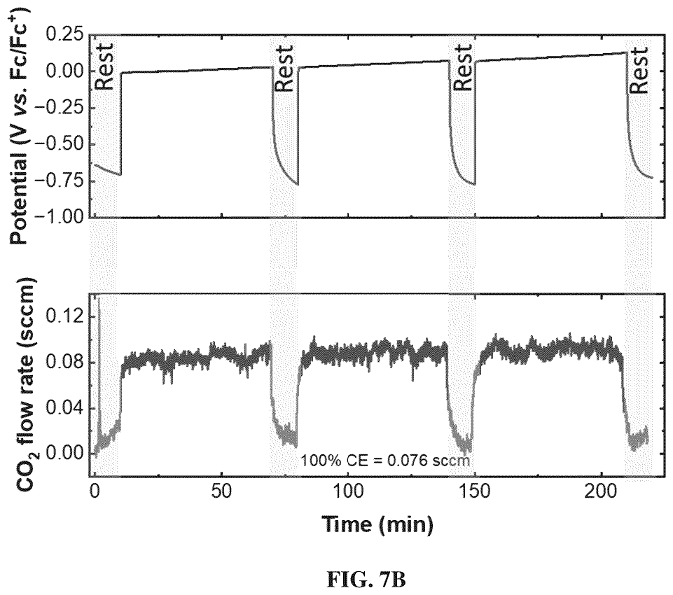

FIG. 7A shows an experimental setup used herein to confirm CO₂ release from NHI-CO₂ upon electro-oxidation. Here, 4-iPr-iPr was used again as a model NHI, and NHI will be used below to refer to 4-iPr-iPr for simplicity. The H-cell contained NHI-CO₂ electrolyte as the anolyte to be oxidized and TEMPO electrolyte as the catholyte to be reduced for charge balance. Carbon cloth was used as the electrode material for both cathode and anode and Ag/Ag⁺ reference electrode was used to record the applied potential during the experiment. The H-cell was sealed with septa to be air-tight and an outlet was connected to the working electrode side to route released gas to a flow meter and CO₂ sensor to characterize the CO₂ release.

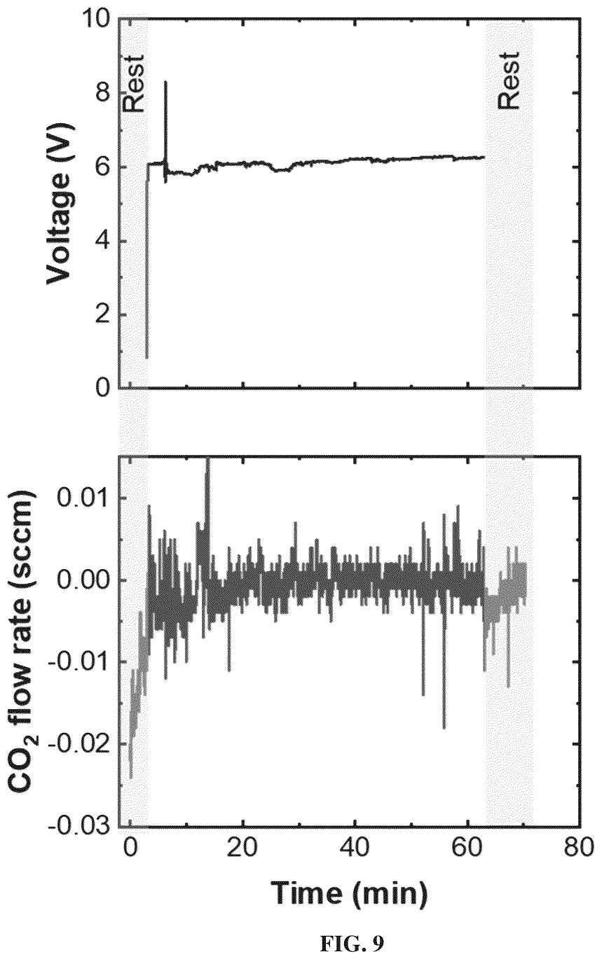

During the experiment, a constant current of 5 mA was passed to the working electrode to oxidize NHI-CO₂. Note that the experiment was designed to pause the current every 60 minutes and rest for 10 minutes to confirm the outlet gas flow difference with and without current. As shown in FIG. 7B, the applied potential was well-controlled around the oxidation peak potential in the CV curve of 4-iPr-iPr under CO₂ atmosphere (FIG. 5). As for the CO₂ released, an increase of the CO₂ flow rate of ˜0.08 sccm was observed when 5 mA current was applied compared to the resting case. Assuming 1 e⁻ oxidation per NHI-CO₂, a theoretical CO₂ release of 0.076 sccm was calculated. Therefore, the results showed evidence that the single electron oxidation of NHI-CO₂ could effectively lead to CO₂ release close to 100% FE. A controlled experiment was also done using anolyte with NHI instead of NHI-CO₂ to confirm the CO₂ release does not originate from any other electrolyte component, as shown in FIG. 9.

There has been growing interest in electrochemical swing processes in recent years, which adopt various strategies to toggle the loading state of a sorbent electrochemically rather than thermally. These electrochemical processes could benefit from using renewables as the energy source, which have much lower CO₂ footprint compared to their thermal counterparts, enhancing the overall CO₂ removal efficiency. One of the representative conventional methods is the direct redox sorbent process. This process activates redox-active organics, such as quinones, bipyridines, and other nitrogen Lewis bases at the cathode as nucleophiles to bind with CO₂ and regenerates them at the anode by electro-oxidation for CO₂ release. However, these types of molecules typically have the issue of the reduction potential being more negative than the oxygen reduction potential in non-aqueous media (e.g., dimethylformamide, dimethyl sulfoxide, etc.). Therefore, during electro-reduction, some of the reductive current could reduce oxygen instead of the targeted molecule, reducing overall FE and energy efficiency. Furthermore, even if the targeted molecule was reduced, it can also turn to reduce the oxygen instead of reacting with CO₂. Given this issue, numerous studies have been conducted to vary the molecular structures of these organics, aiming to shift the reduction potential of these molecules in the positive direction. With various strategies to tailor the molecular structures of quinones (e.g., BQ, DBQ, TBQ, BQ-Cl₂, BQ-Cl₄, p-Naphthoquinone (p-NQ), p-NQ-Me₂, p-NQ-Cl₂, AQ, AQ-Cl, AQ-O—C₃H₇, AQ-COO—C₃H₇, AQ-CONH—C₄H₉, o-NQ, PQ, PQ-I, and PQ-I₂) and nitrogen Lewis bases, the reduction potentials of these organic molecules were still usually lower than O₂ reduction potential. Moreover, it has been reported that there existed trade-off between the redox potential and the strength of electrochemical CO₂ capture. Therefore, even with few cases that the molecules possessed more positive reduction potential compared to O₂, their CO₂ binding strength attenuated as well.

The NHIs described herein demonstrated the advantages of serving as direct redox sorbents. It was demonstrated that the molecular structure of the NHIs can be tuned by tailoring the functional groups on three molecular positions, enabling a broad range of favorable reaction enthalpies with CO₂ and achieving high CO₂ loading under industrially relevant conditions. Furthermore, it was shown that the NHI-CO₂ adduct can be electrochemically regenerated via oxidation, completing the redox-driven CO₂ capture and release cycle. Utilizing NHIs as the direct redox sorbent possesses significant advantage over existing materials. As shown in FIG. 5, the redox potential of 4-iPr-iPr is at ˜0 V vs. Fc/Fc⁺ under CO₂ atmosphere. This is a significant positive shift of the potential compared to other conventional sorbents, which can effectively prevent any unwanted O₂ reduction reaction. An additional benefit of NHI is that even with this favorable positive shift of the potential, the CO₂ binding strength was not sacrificed as the conventional redox sorbents did. This is because NHI's CO₂ binding strength is determined in its original state, and thus does not have any correlation with its reduction potential.

The NHIs and related methods disclosed herein have relevance to management of concentrated CO₂ emission streams in the power generation sector and from industry (e.g., cement, ethylene and other petrochemicals, hydrogen), as well as potentially from dilute sources (e.g. direct-air capture) given the improved oxygen tolerance.

### Example

Electrochemically mediated CO₂ capture (EMCC) offers a promising alternative to thermochemical capture, but state-of-the-art sorbents possess an undesired trade-off: strong CO₂ binding necessitates a highly negative reduction potential, driving reduction into a region competitive with undesirable oxygen reduction. Meanwhile, more positive potentials compromise binding. As described herein this tradeoff is circumvented using N-heterocyclic imines (NHIs), which exhibit a tailorable CO₂ binding strength (˜50-100 kJ/mol CO₂) in the neutral state and release CO₂ with near theoretical Faradaic efficiency upon electro-oxidation, distinct from conventional molecular capture mechanisms. While initial NHI structures exhibited redox irreversibility due to solvent-based hydrogen abstraction, an improved design, based on phenylene-linked bis(NHI), achieves redox reversibility by charge delocalization on the benzene ring. This design enables an unprecedented 2 CO₂/e⁻ swing, doubling the Faradaic efficiency of known sorbents. A symmetric EMCC system demonstrated stable cycling performance over 40 cycles and operated >500 mV more positive than the oxygen reduction reaction, with a theoretical minimum energy consumption of ˜10 kJ/mol CO₂.

EMCC has emerged as a promising alternative to conventional amine-based separation. By directly or indirectly modulating the chemical state of sorbents through electrical potentials, EMCC enables CO₂ separation to operate under ambient temperature and pressure and be powered by renewable energy. A prominent approach involves the use of redox reversible organic compounds, such as quinones, bipyridines, and other Lewis bases in non-aqueous solvents. These compounds bind CO₂ after undergoing an electrochemical reduction reaction to become nucleophilic and release CO₂ upon oxidation. However, these organic sorbents generally require highly negative redox potentials (typically <−1.25 V vs. Fc/Fc⁺) which can initiate parasitic oxygen reduction, compromising system efficiency and stability. The competition with oxygen redox can be addressed in part by structural modification, such as grafting electron-withdrawing groups to shift the sorbent redox potential positively, but this tends to significantly weaken CO₂ binding strength, creating an undesired trade-off.

Recently, NHIs have shown promise as CO₂ sorbents. NHI molecular modification allows for the basicity to be readily tuned. Structural and spectroscopic analyses of NHI-CO₂ adducts, as well as applications in reversible thermal- and photo-swing CO₂ capture, have been studied, but activity under electrochemical conditions has not been explored. It was hypothesized that electro-oxidation might selectively decrease the nucleophilicity of the imine and induce CO₂ release. This would be a compelling prospect because, unlike in current paradigms, NHI reacts with CO₂ in its neutral state, i.e. no electro-reduction occurs before CO₂ capture takes place. This allows for the reaction enthalpy of NHI and CO₂ (ΔH_{NHI-CO2}) to be directly measured and fine-tuned.

A series of NHLs with diverse structural modifications was investigated to elucidate the substituent effects on ΔH_{NHI-CO2} and on the achievable CO₂ loading, identifying compounds with suitable CO₂ binding energies. Subsequently, the redox behavior upon oxidation was examined, observing that CO₂ release occurs with near-theoretical Faradaic efficiency. However, an oxidatively driven side reaction, attributed to hydrogen abstraction from the solvent by the NHI radical cation, occurred in the first set of examined sorbents, hindering a return to the neutral NHI state for reversible, cyclical capture. To address this, a phenylene-substituted bis(NHI) was designed to mitigate these issues, and a capture-first EMCC process was demonstrated with compelling performance metrics: reduction potential >500 mV more positive than oxygen reduction, an unprecedented release of two CO₂ molecules for a single electron transfer, and a projected energy consumption of −10 kJ/mol CO₂.

Influence of NHI Structure on Thermochemical Capture Properties: An initial series of NHIs was synthesized starting from commercially available urea, imidazolium salt or thiourea. The structures of the prepared NHIs were systematically varied on the backbone, side chain, and at the exocyclic nitrogen, with the latter serving as the CO₂ binding site (FIG. 2A). NHIs with five different backbones (1-5, FIG. 2B) were selected for electronic diversity, with methyl (Me) and isopropyl (iPr) functional groups on the heterocyclic and exocyclic nitrogen, respectively. Given their superior reactivity with CO₂, NHIs 4 and 5 were further modified by varying their side chain and exocyclic functional groups using methyl, isopropyl, and tert-butyl (tBu) substitutions to introduce greater control over steric effects which affect the CO₂ binding. All new compounds were characterized by heteronuclear NMR (¹H and ¹³C) and mass spectrometry as analytically pure solids or oils.

The reaction enthalpy, ΔH_{NHI-CO2}, of 0.1 M NHI in DMSO was measured in an isothermal micro reaction calorimeter (μRc) under 100% CO₂ gas flow at 25° C., and normalized according to the measured CO₂ loading. DMSO was used because of its high boiling point, which minimizes quantification error. It was confirmed that the solvent selection (DMSO, DMF, or MeCN) does not affect the measured ΔH_{NHI-CO2}. ΔH_{NHI-CO2} of compounds 1 (benzene backbone) and 2 (saturated backbone) was negligible (FIG. 3, top), indicating that these compounds do not form stable adducts with CO₂. On the other hand, the isologous NHIs with unsaturated backbones (3, 4, and 5) had ΔH_{NHI-CO2} ranging from −57 to −83 kJ/mol CO₂, presumably due to additional n electrons in the heterocycle. Incorporation of electron-withdrawing (e.g., phenyl for 3, ΔH_{NHI-CO2}=−57 kJ/mol) or electron-donating (e.g., Me for 5, ΔH_{NHI-CO2}=−83 kJ/mol) groups on the backbone provide an effective approach for tuning the CO₂ affinity within similar frameworks.

Given the excellent reactivity of 4 and 5 with CO₂, which possess comparable reaction enthalpy as conventional amines (˜70-85 kJ/mol CO₂), their sidechain functional groups and the exocyclic nitrogen were systematically varied to investigate the steric effects on NHI-CO₂ adduct stability (FIG. 3, bottom). In all cases, the measured ΔH_{NHI-CO2} became more negative as the steric hindrance on NHIs increased from Me to iPr and tBu on the side chain and/or the exocyclic nitrogen positions. A similar trend—decreasing ΔH_{NHI-CO2} with increasing steric hindrance—was observed in a computational study. Here, a first quantification of the steric effect is provided experimentally, revealing that steric control allows for tuning the reaction enthalpy by approximately 10-20 kJ/mol CO₂ (e.g., compare ΔH_{NHI-CO2} for 4 (−74 kJ/mol CO₂) vs. 4-tBu-iPr (−84 kJ/mol CO₂); and 4-iPr-Me (−80 kJ/mol CO₂) vs. 4-iPr-tBu (−97 kJ/mol CO₂)). This can be rationalized by the fact that increasing the steric hindrance increases the intramolecular steric repulsion and destabilizes the lean NHI, as the exocyclic C═N double bond is unable to rotate. However, as CO₂ reacts with NHI, the C—N bond elongates towards a single bond that can rotate, releasing the steric repulsion. Therefore, a more hindered NHI releases more energy after reacting with CO₂, leading to a more negative ΔH_{NHI-CO2}.

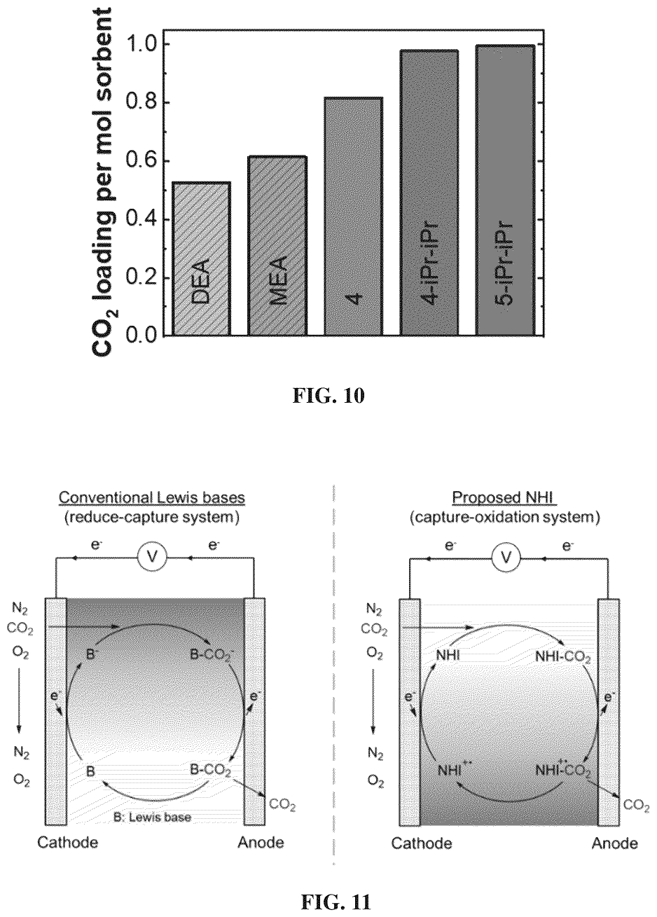

The CO₂ loading of 1 M solutions of representative NHIs was measured (FIG. 4A) in 1,3-dimethyl-2-imidazolidinone (DMI) and compared to conventional 1 M aqueous amines (MEA and DEA). For these experiments. DMI was selected as the solvent due to its high dissolution of both NHI and NHI-CO₂, and thus ability to examine CO₂ uptake at relatively high concentrations more relevant for comparison with commercial aqueous amines. Three representative NHIs (4, 4-iPr-iPr, and 5-iPr-iPr) were selected to span a representative range of reaction enthalpies in the moderate-to-strong binding regime with CO₂. Upon purging 15% CO₂ into each sorbent, 5-iPr-iPr most effectively reduced the outlet CO₂ concentration from 15% to 0.4%, compared to 4-iPr-iPr (1.2%) and 4 (4.3%, FIG. 4B). It is noteworthy that NHIs 4 and 4-iPr-iPr markedly outperform the CO₂ capture rate and extent of conventional amines that possess similar reaction enthalpies (DEA: −74 kJ/mol CO₂ and MEA: −85 kJ/mol CO₂). The CO₂ loadings for various sorbents were further calculated by integrating the amount of captured CO₂ over time (FIG. 10). All sorbents reached apparent maximum loading after 20 minutes, with 4, 4-iPr-iPr, and 5-iPr-iPr yielding loadings of 0.82, 0.97, 0.99 mol CO₂/mol sorbent respectively (background CO₂ solubility of DMI was measured and subtracted), showing a higher achievable CO₂ loading than conventional MEA and DEA (˜0.5-0.6 mol CO₂/mol sorbent). Given its excellent performance, the achievable CO₂ loading of 4-iPr-iPr was further examined in dilute (5% and 2.5%) CO₂ streams (FIG. 4D) and observed a comparably high CO₂ loading of 0.93 and 0.90 mol CO₂/mol sorbent under both conditions, suggesting that NHI have strong potential for scrubbing low CO₂ concentrations.

Electrochemical Behavior of NHIs as EMCC Sorbents: The proposed working cycle for EMCC begins with NHI binding CO₂ in the neutral state (FIG. 11). Electro-oxidation at the anode induces CO₂ release, whereas subsequent reduction of oxidized NHI at the cathode regenerates the sorbents. This “capture-oxidation” system is distinct from the “reduce-capture” paradigm predominant in quinones and other EMCC sorbents. Hence, the ability to release CO₂ upon oxidation and be subsequently reduced to neutral species reversibly are key differences.

Cyclic voltammetry (CV) of 1, 2, 3, 4-iPr-iPr, and 5-iPr-iPr at 50 mV/s under Ar (grey lines) and CO₂ (colored lines) is shown in FIG. 5. Lean NHIs exhibited intrinsic redox activity under Ar with a variable oxidation peak potential ranging from −0.35 to 0.35 V vs. Fc/Fc⁺, with stronger-binding NHLs having more negative peak potentials. This is rationalized by a higher electron density on the exocyclic nitrogen for more nucleophilic NHIs, leading to easier oxidation at less positive potentials. However, even with strong CO₂ binding (e.g., −92 kJ/mol CO₂ for 5-iPr-iPr), the redox potentials of these NHIs (>−0.25 V vs. Fc/Fc⁺) remain significantly higher than that of oxygen reduction (<−1.25 V vs. Fc/Fc⁺). This result demonstrated that the use of NHI allows both positive redox potentials and high CO₂ affinity to be achieved at the same time. Since the imine is the only shared functional group and these NHIs showed similar redox behaviors, it was concluded that the exocyclic nitrogen is the redox center in the examined potential range. However, all CV curves showed various degree of irreversibility under Ar, signaling a chemical side reaction occurring after the initial oxidation, which hampers further reduction. Notably, compound 3 features a small reduction wave, which disappears when the scan rate was decreased to 10 mV/s, providing corroborating evidence for a competing side reaction.

Under CO₂ atmosphere, the NHLs that do not form stable adducts with CO₂ (i.e., 1 and 2) showed, as expected, little to no shift of the oxidation potential. NHIs that bind CO₂ (i.e., 3, 4-iPr-iPr, and 5-iPr-iPr), however, showed oxidation potentials shifted to more positive values compared to the Ar case, to a degree roughly proportional to the binding strength. Using 4-iPr-iPr as a representative case, chronopotentiometry experiments were conducted to oxidize NHI-CO₂ in an H-cell setup at constant current (5 mA) and it was observed that the oxidation of NHI-CO₂ effectively stimulates CO₂ release with nearly theoretical Faradaic efficiency (FE), assuming 1 e⁻ oxidation per NHI-CO₂. As observed under Ar atmosphere, these NHIs could not be returned to the neutral state by electroreduction under CO₂ atmosphere.

After oxidation (1e⁻ per NHI) under Ar in 0.25 M TBABF₄/MeCN, ¹H NMR revealed that 4-iPr-iPr underwent structural change to yield a new species attributable to 4-iPr-iPr-HBF₄ due to resonances that align with protonation of the exocyclic nitrogen (FIG. 6). It was proposes that electro-oxidation of this first set of structures yields an unstable NHI radical cation on the exocyclic nitrogen, which initiates hydrogen abstraction to form 4-iPr-iPr-HBF₄. The hydrogen source in the electrolyte could in principle be residual water, however the water content of the electrolyte was measured to be below 20 ppm (˜1 mM), i.e., insufficient from a mass balance perspective to protonate the NHI (200 mM). The same experiment, using LiBF₄ instead of TBABF₄, ruled out the organic cation as the source of instability, leading to the conclusion that MeCN is the hydrogen source for proton abstraction by NHI. Unfortunately, other common solvents (e.g. DMSO, DMF. PC, and DFB) were also unable to support reversible NHI redox behavior for these structures. As a result, subsequent efforts were directed toward redesigning the NHI structure for reversibility.

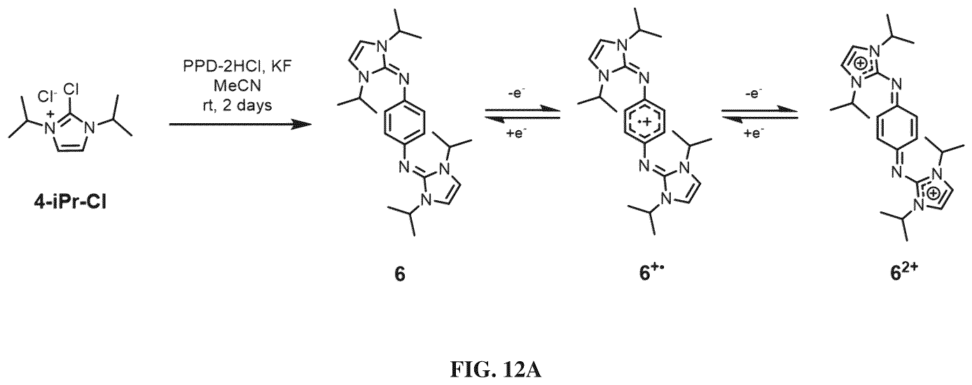

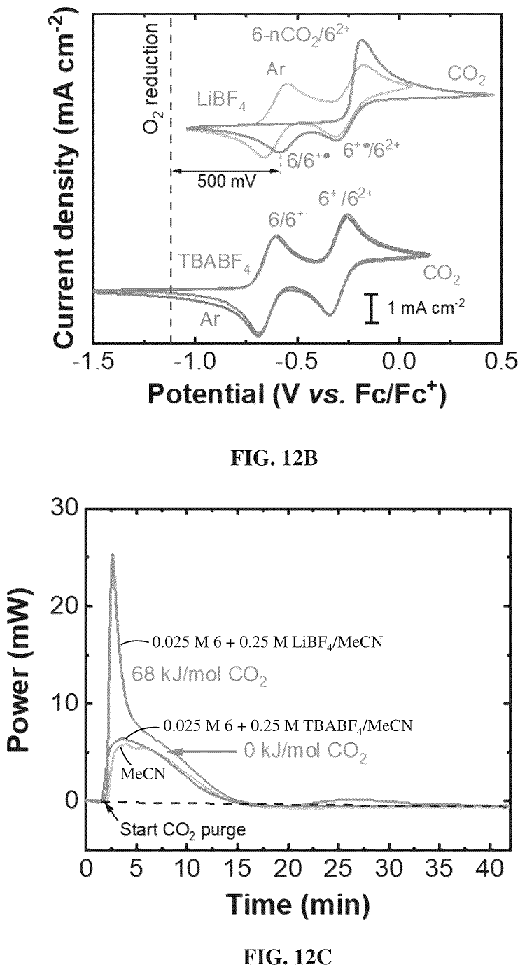

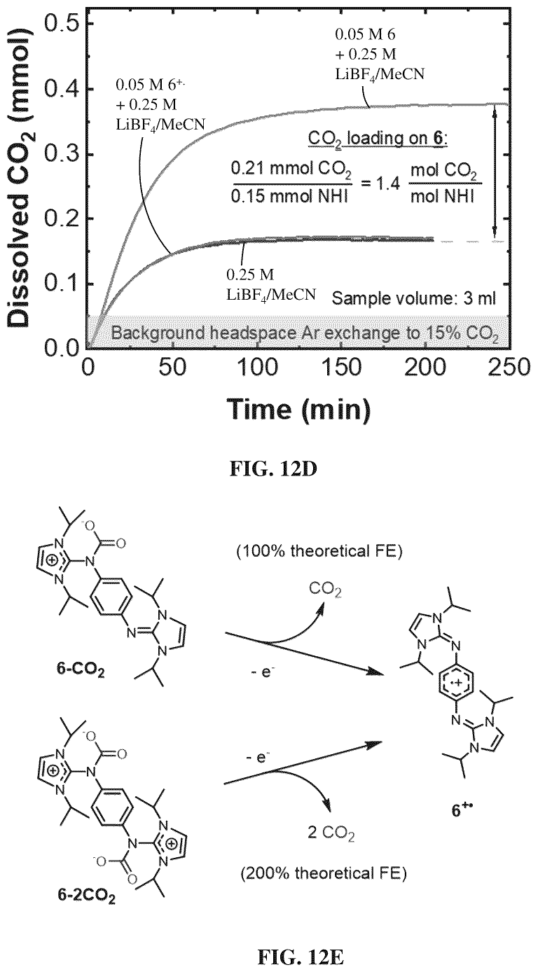

Design of Redox-Reversible NHI: Rational molecular design, with the aim of stabilizing the putative NHI radical cation and preventing solvent hydrogen abstraction, was explored by extending the NHI resonance structure. It has been shown that a phenylene linkage between two NHIs induces facile one- and two-electron transfer for proton-coupled-electron-transfer (PCET) reactions, and the radical cation formed after one-electron oxidation could be effectively stabilized on the aromatic ring by charge delocalization. Inspired by these results, a similar framework for NHIs was synthesized with an unsaturated backbone (FIG. 12A), since the latter has been shown for spontaneous CO₂ capture. The CV of phenylene-substituted bis(NHI) (6) under Ar (0.25 M TBABF₄/MeCN) indeed showed two set of reversible redox peaks, corresponding to the redox of 6/6^{+·} at −0.65 V vs. Fc/Fc⁺ and 6^{+·}/6²⁺ at −0.3 V vs. Fc/Fc⁺, respectively (FIG. 12B). However, compound 6 does not form a stable adduct with CO₂ in 0.25 M TBABF₄/MeCN electrolyte as evidenced by negligible binding enthalpy (FIG. 12C) and identical CV curves under Ar and CO₂ (FIG. 12B). Previous work on CO₂ capture using nonaqueous amine solutions found that strong Lewis acid cations electrostatically interact with carbamate anions, significantly contributing to their stabilization. Therefore, it was hypothesized that changing from a soft-acid organic cation (TBA⁺) to a hard-acid alkali cation might address the issue. Indeed, the incorporation of Li⁺ salt was found to significantly change the CV curve of 6 under CO₂ (FIG. 12B), such that it exhibited only the second oxidation peak at ca. −0.2 V vs. Fc/Fc⁺—consistent with direct oxidation of 6-nCO₂ to 6²⁺—while maintaining the same stepwise reduction peaks on the reverse scan. Calorimetry testing further confirmed that Li⁺ salts effectively stabilize the NHI-CO₂ adduct, yielding ΔH_{NHI-CO2} of −68 k/mol CO₂ (FIG. 12C) and a CO₂ loading of 1.4 mol CO₂ per mol NHI under 15% CO₂ at 0.05 M concentration (FIG. 12D). The first-order CO₂ capture rate constant of NHI 6 in the Li⁺/MeCN electrolyte was measured to be 7.4×10⁴ M⁻¹s⁻¹, which is on par with commercial piperazine (7×10⁴ M⁻¹s⁻¹ at 25° C.).

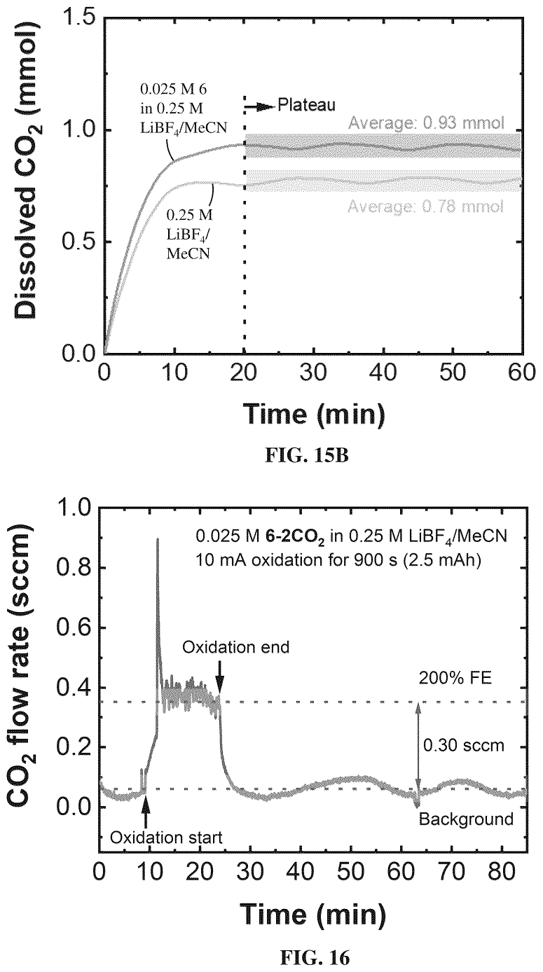

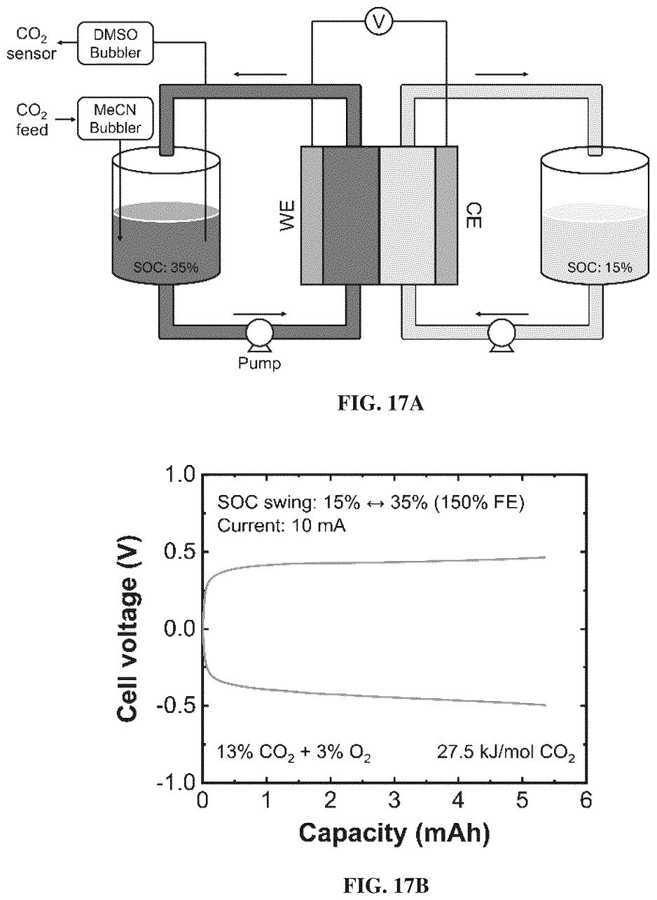

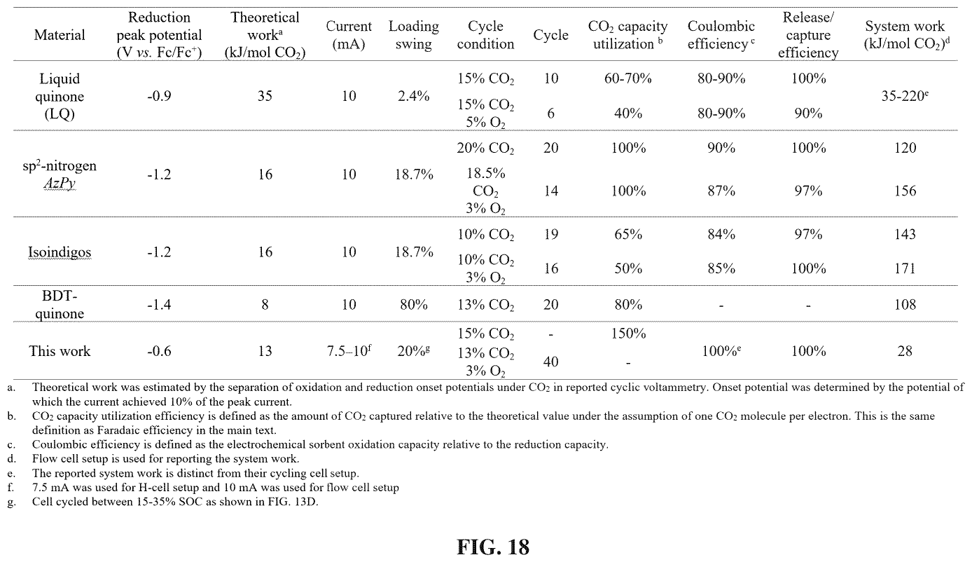

NHI 6 contains two exocyclic nitrogen binding sites per molecule, thus, a CO₂ loading of 1.4 mol CO₂ per mol NHI indicates that some proportion of NHI are fully loaded. Additionally, the absence of the first oxidation peak (6/6^{+·} at −0.65 V vs. Fc/Fc) in the cyclic voltammetry (CV) response of 6 under 15% CO₂ signifies the absence of lean 6, implying 60% 6-CO₂+40% 6-2CO₂ as the only possible speciation. To inform EMCC cycle parameter design (i.e., state-of-charge (SOC) swing), CO₂ loadings in the two possible oxidized states (6^{+·} vs. 6²⁺) were further investigated. Electrochemically-generated 0.05 M 6^{+·} in 0.25 M LiBF₄/MeCN exhibits a CO₂ loading identical to that of the background electrolyte (only physically-dissolved CO₂), indicating an inability to form a stable adduct with CO₂. This suggests that all bound CO₂ from 6 is readily released upon electrochemical oxidation to 6^{+·}, such that each NHI molecule requires, in principle, only a single electron transfer to release all CO₂. Intriguingly, this points to theoretical FEs of 100% (1 CO₂/e⁻ for 6-CO₂) and 200% (2 CO₂/e⁻ for 6-2CO₂), as illustrated in FIG. 12E. The latter pathway was confirmed upon increasing the CO₂ partial pressure to 100%—which exclusively forms the dually-loaded 6-2CO₂ (FIGS. 15A-15B)—followed by chronopotentiometry, which yielded a ratio of 1.97 CO₂/e⁻, providing direct evidence that NHI 6 is intrinsically capable of undergoing oxidation at a ratio approaching 2 CO₂/e⁻ (FIG. 16).

Herein, state-of-charge (SOC) is defined as the ratio of the charge passed to oxidize 6 to the maximum theoretical charge that can be passed to oxidize all 6 to 2+ state. For the SOC increase from 0 to 50%, the system started from 100% 6 and oxidized to 100% 6^{+·}. For the SOC increase from 50 to 100%, the system started from 100% 6^{+·} and oxidized to 100% 6²⁺.

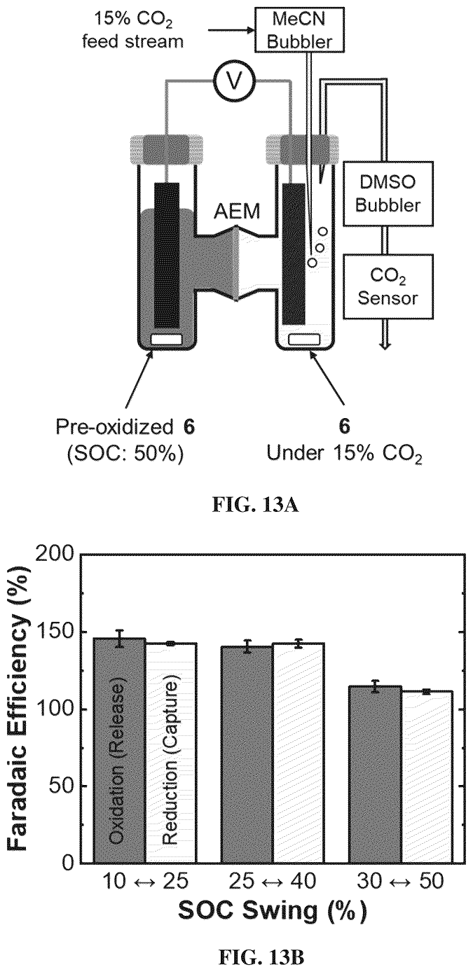

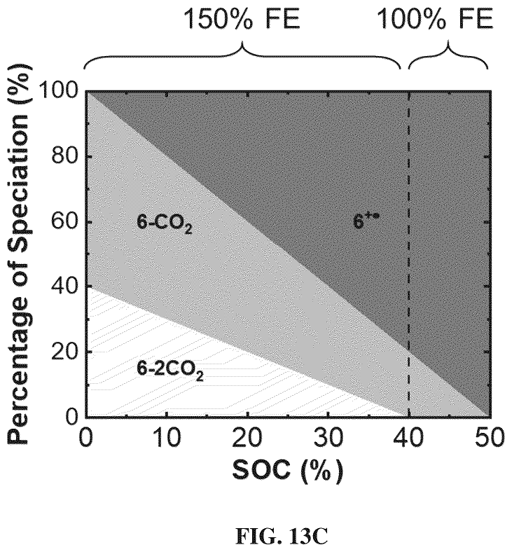

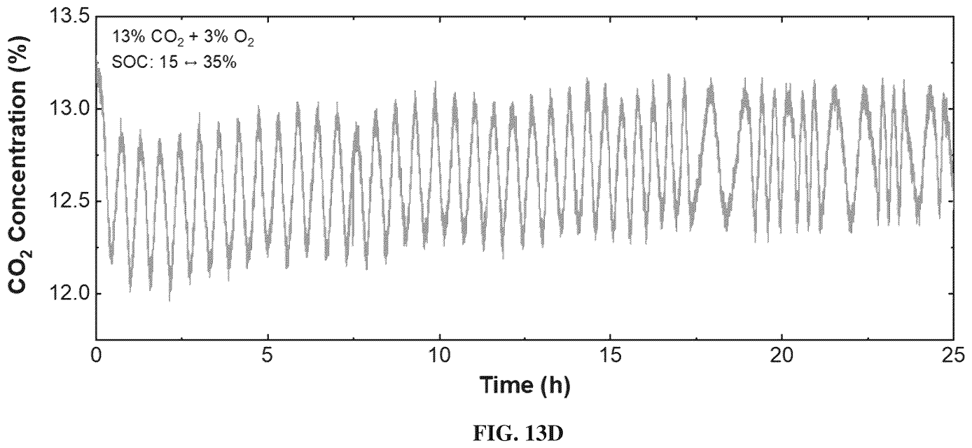

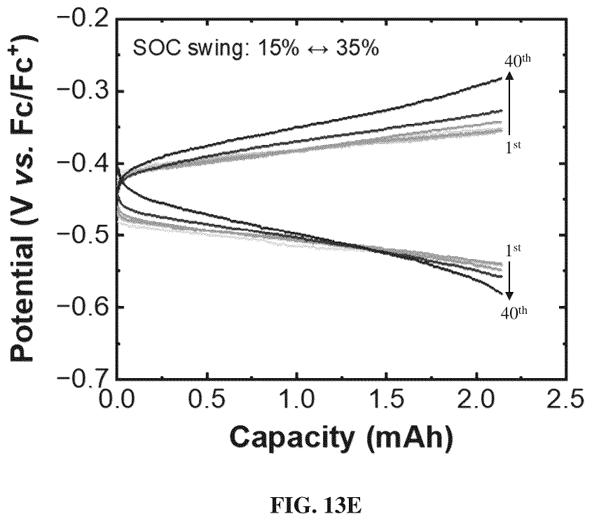

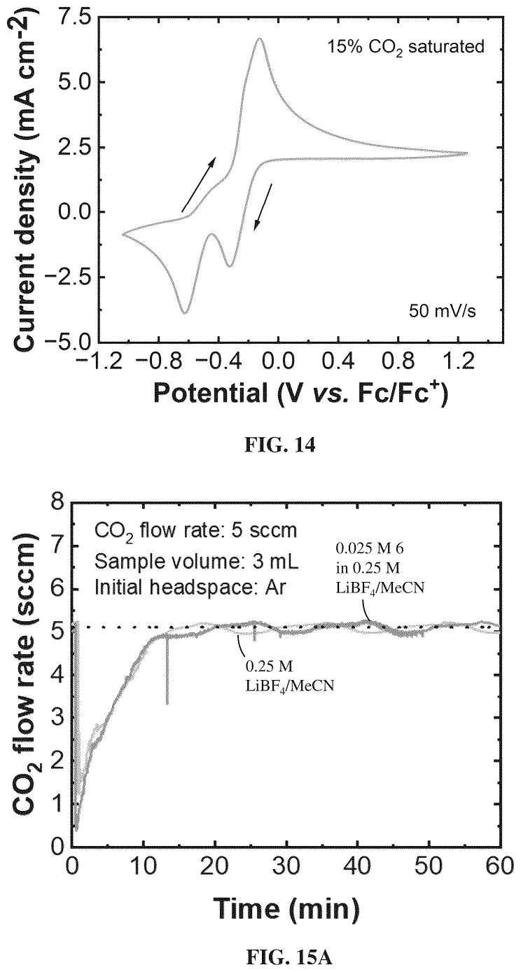

To explore this point further under more-practical conditions, the FEs of CO₂ release/capture at 15% CO₂ were measured in a symmetric H-cell setup (FIG. 13A). Three SOC ranges (10-25%, 25-40%, and 30-50%) were examined and yielded FEs (oxidation/reduction) of 145%/142%, 140%/142%, and 114%/111%, respectively (FIG. 13B). The FEs in these three SOC ranges (150% for 10-25%; 150% for 25-40%; 125% for 30-50%) matches well with the modeled FEs assuming a starting composition of 60% 6-CO₂+40% 6-2CO₂, followed by proportional (i.e., non-preferential) oxidation of 6-CO₂ and 6-2CO₂, as shown in FIG. 13C. It was noted that the assumption of concurrent oxidation is well-supported by the single oxidation peak observed in the CV curve under 15% CO₂ (FIG. 14), which shows no clear oxidation order for either adduct. Since 6-CO₂ and 6-2CO₂ are oxidized concurrently and 6-2CO₂ (40% speciation) is depleted earlier than 6-CO₂ (60% speciation) by simple proportionality arguments, there is no SOC window in the present system (15% CO₂) that exclusively cycles 6-2CO₂ to realize the highly compelling theoretical FE of 200% (FIG. 13C).

The redox potentials of 6 are >500 mV more positive than the oxygen reduction potential in 0.25 M LiBF₄/MeCN electrolyte, showing strong propensity to avoid deleterious oxygen reduction reactions. For the current NHI design, continuous CO₂ capture/release was attained over the SOC range of 15-35% for 40 cycles under 13% CO₂+3% O₂ as evidenced by the stable CO₂ concentration swing during operation (FIG. 13D). In an H-cell, the average potential separation between oxidation and reduction for each cycle is 130-160 mV from the 1^{st} to the 40^{th} cycle (FIG. 13E), corresponding to energy consumption of 8.4-10.3 kJ/mol CO₂ under the assumption of 150% theoretical FE and constant CO₂ concentration. Under a practical CO₂ differential (capture at 0.15 bar and release at 1 bar), the requirement increases modestly (22 kJ/mol CO₂). After the 40^{th} cycle, however, an increase of the reduction polarization occurs and is attributed to radical cation decay over time. Performance under elevated O₂ (17%) also remains comparable to that observed at low 02 levels (3%). Given the promising metrics above, the energy consumption was further examined in a flow-cell setup and was measured to be 27.5 and 43.2 kJ mol⁻¹ CO₂ under 15% and 5% CO₂ (FIGS. 17A-17B), respectively, with the main difference being the CO₂ loading (1.4 vs. 1.1 mol CO₂/mol NHI) and achievable FE (150% vs. 100%). These results demonstrate strong promise compared with other existing EMCC processes (35-220 kJ mol⁻¹ CO₂, FIG. 18).

The energy consumption of the process using the flow-cell setup (FIG. 17A) was calculated according to the following equation:

$$Energy consumption ( \frac{kJ}{mol} ) = \frac{Net energy in the reduction + oxidation cycle}{Total {CO}_{2} capture and release}$$

The net energy was obtained by integrating the cell voltage over the capacity, and a FE of 150% was assumed to estimate the amount of CO₂ captured and released during the experiment (recognizing that the CO, signal requires 5-6 h to return to baseline and that slow water ingress into the cell leads to NHI protonation and additional CO₂ release, which prevents accurate isolation of the charge-induced CO output. Based on the data shown in FIG. 17B, the energy consumption was determined to be 27.5 kJ mol⁻¹ CO₂ at a total current of 10 mA (˜2 mA cm⁻²).

These findings highlight bis(NHI) as a class of promising EMCC material with high reduction potentials, high capacity, and low projected energy consumption.

This example demonstrates the potential of NHIs as a class of redox-active CO₂ capture sorbent. NHIs possess widely tunable reaction enthalpies (˜50-100 kJ/mol CO₂), which are readily modulated by controlling the heterocycle backbone electronic properties and the steric hindrance around side chain and exocyclic nitrogen substituents. With similar reaction enthalpy as conventional amines (e.g. MEA. DEA). NHIs were found to possess improved CO₂ capture capacity and kinetics. The investigation showed that the NHI molecular class can effectively decouple CO₂ capture enthalpy from the need for a highly negative redox potential because of their electron-rich nature, with reduction potentials separated by >500 mV from the oxygen reduction potential. Furthermore, the phenylene-substituted bis(NHI) showed increased stability against unfavorable side reactions triggered by electrochemical oxidation without compromising CO₂ capture capacity, alongside an unprecedented CO₂ capture/release mechanism with theoretical 200% FE, stable cycling over 40 cycles, and a theoretical minimum energy consumption of −10 kJ/mol CO₂.

General synthesis procedures and characterization: All air- and moisture-sensitive reactions were performed under an inert Ar atmosphere using standard Schlenk line techniques or in an MBRAUN Ar glovebox equipped with a −37° C. freezer. All glassware used for reactions was oven-dried at 190° C. overnight. Proton and carbon nuclear magnetic resonance (¹H and ¹³C NMR) spectra were obtained using a Bruker Avance Neo 400 or 500 MHz, or a Bruker Avance-Ill HD Nanobay 400 MHz. All samples were prepared with the dried deuterated solvent and loaded in a capped Wilmad NMR tube (700 μl). Mass spectrometry data were measured on a high-resolution JEOL AccuTOF 4G LC-plus equipped with an ionSense direct analysis in real time (DART).

NHI-CO₂ reaction enthalpy measurements: Experiments were performed using a Micro Reaction Calorimeter (uRC™, Thermal Hazard Technology) equipped with a gas flow option. In a typical experiment, 0.7 ml of sample comprising the desired concentration of NHI in DMSO. MeCN or DMF was loaded into a 1.5 ml stainless-steel vial and purged with 1 sccm of 100% CO₂. The heat signal was continuously monitored until it returned to baseline, indicating saturation. The enthalpy of reaction was determined by integrating the heat flow peak. All reported reaction enthalpy values are background-corrected by subtracting the heat associated with CO₂ dissolution in the pure solvent, determined through independent control measurements.

NHI-CO₂ loading determination: In a typical experiment, a gas-tight vial (SureSTART™ 10 mL glass screw top headspace vial) was used to load the sorbent solution. A needle/tubing apparatus connected upstream to purge gas was plugged through the septum into the electrolyte, and the inlet CO₂ concentration was regulated by adjusting the ratio of CO₂ and N₂ gases using flow controllers. A second needle/tubing apparatus directed outflow to a gas flow meter (Alicat Scientific) and a CO₂ IR sensor (GC-0025 0-100% and GC-0015 for 0-5% CO₂ concentration, CO2 Meter), which was calibrated before each measurement. The difference of inlet and outlet CO₂ flow rate was integrated over time to calculate the total amount of CO₂ captured.

Electrochemical measurements: Cyclic voltammetry was conducted in a glass three-electrode (Pine Research low-volume) cell equipped with glassy carbon working electrode. Pt counter electrode, and Ag/Ag⁺ reference electrode (Pine Research, LowProfile Glass Frit Ag Pseudo Reference Electrode). The testing electrolyte was saturated with Ar or 100% CO₂ before the measurement, as indicated. Ferrocene was used as an external standard to convert the potential of the reference electrode from Ag/Ag⁺ to Fc/Fc⁺ (Fc/Fc⁺=0.06 V vs. Ag/Ag⁺).

To examine the oxidation product, electrolysis of 4-iPr-iPr was carried out using carbon felt as the working and counter electrodes and an Ag/Ag⁺ reference electrode in a low volume H-cell separated with an anion exchange membrane (Fumasep FAB-PK-130). The carbon electrodes were dried under vacuum at 100° C. overnight to remove residual water. The membrane was pretreated by soaking in 0.25 M TBABF/MeCN or 0.25 M LiBF₄/MeCN for at least two days before usage, depending on the electrolyte salts to be used in the experiments. The catholyte was 0.25 M TEMPO in 0.25 M TBABF₄/MeCN or 0.25 M LiBF/MeCN. Oxidation was conducted galvanostatically at 5 mA to fully oxidize 4-iPr-iPr-CO₂. The electrolyte after oxidation was then analyzed by ¹H NMR.

Faradaic efficiency of CO₂ release/capture and long-term cell cycling: Experiments were conducted in a low-volume H-cell as described above. The initial cell construction employed carbon felt as the working electrode, paired with a Zn foil counter electrode operating in 0.05 M Zn(TFSI)₂ in 0.25 M LiBF₄/MeCN, to oxidize 4.5 mL of 0.05 M NHI in 0.25 M LiBF/MeCN to 50% SOC. Zn foil is for smooth Zn plating to achieve charge balance. The oxidized NHI electrolyte and carbon felt were subsequently transferred to a new H-cell to serve as the catholyte, while fresh 0.05 M NHI and new carbon felt were used in the working electrode compartment. The H-cell was then taken out of the glovebox and the working chamber was continuously purged with 2 sccm of 15% CO₂ (FIG. 13B) or 13% CO₂+3% O₂ (FIGS. 13D and 13E), and the outlet stream was passed through a DMSO bubbler. For FE quantification, NHI oxidation or reduction was conducted by passing a constant 7.5 mA current for 772 s (15% SOC swing) or 1029 s (20% SOC swing), and the cell was rested for 5 hours after electrolysis to allow the CO₂ signal to equilibrate back to the 15% baseline. The extended resting time was attributed to the buffer effect of the DMSO bubbler, which slows down changes in CO₂ concentration. For long-term cycling experiments, an Ag/Ag⁺ reference electrode was added to monitor the working electrode potential.

Calculation of Faradaic efficiency (FE): During a state-of-charge (SOC) swing experiment (FIG. 13B), the change in CO₂ concentration, monitored using a CO₂ sensor, was used to quantify the FE. A baseline for the integration was defined by two reference points: the average CO₂ concentration at the beginning of the measurement and the average concentration after the signal relaxed back to equilibrium at the end of the measurement. Due to minor sensor drift over time, this baseline is not strictly horizontal. The resulting peak was integrated to obtain the integrated area (Aₚₑₐₖ), and the total amount of measured CO₂ captured or released (n_{CO2,measured}) was then calculated using the following equation:

$${n}_{CO 2 , measured} = {A}_{peak} \dot{m} \frac{P}{R T}$$

where \dot{m} is the mass flow rate of 15% CO₂ (2 sccm), P is the pressure, R is the ideal gas constant, and T is the temperature. Theoretical amount of CO₂ captured or release (n_{CO2,theory}) was calculated using the following equation:

$${n}_{CO 2 , theory} = \frac{Q}{F}$$

where Q is the total charge passed during the experiment (C) and F is the Faradaic constant (C/mol). The FE is then calculated by:

$$FE = \frac{{n}_{CO 2 , meαsured}}{{n}_{C O 2 , theory}}$$

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims. “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims. “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of.” or “exactly one of.” “Consisting essentially of.” when used in the claims, shall have its ordinary meaning as used in the field of patent law.

As used herein in the specification and in the claims, the phrase “at least one.” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding.” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures. Section 2111.03.

1. An electrochemical cell, comprising:
a first electrode;
a second electrode; and
a carbon dioxide (CO₂) adduct comprising a reaction product between CO₂ and a N-heterocyclic imine (NHI) compound of Formula (I) and/or a metal ion-stabilized derivative thereof: 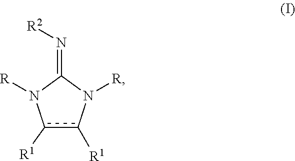
wherein:
each R is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; and/or (iii) at least one R combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iv) each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
each R¹ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂; and/or (ii) at least one R¹ combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
R² is selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, N(R³)₂, and a NHI moiety, each of which is optionally substituted, and wherein one or more optional substituents comprise a NHI substituent, and
each R³ is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, each of which is optionally substituted.

2. The electrochemical cell of claim 1, wherein the first electrode is contained within a first compartment and the second electrode is contained within a second compartment.

3. (canceled)

4. The electrochemical cell of claim 2, wherein the first compartment comprises a first electrolyte, and the first electrolyte comprises the CO₂ adduct.

5-9. (canceled)

10. The electrochemical cell of claim 1, wherein the electrochemical cell is a flow cell.

11. The electrochemical cell of claim 1, wherein each R is individually selected from the group consisting of a methyl group, an isopropyl group, and a tert-butyl group.

12. The electrochemical cell of claim 1, wherein each R¹ is individually selected from the group consisting of hydrogen, a methyl group, and a phenyl group.

13. The electrochemical cell of claim 1, wherein R² is selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted.

14. The electrochemical cell of claim 13, wherein R² is selected from the group consisting of a methyl group, an isopropyl group, and a tert-butyl group.

15. (canceled)

16. The electrochemical cell of claim 1, wherein R² is: 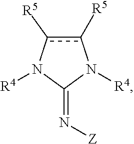
wherein:
each R⁴ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R⁴ combines together with at least one R⁵ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R⁴ combines together with the atoms to which they are attached to form a C₃-C₂₀ cycloalkyl group, a C₃-C₂₀ heterocyclocalkyl group, a C₆-C₄₀ aryl group, or a C₅-C₄₀ heteroaryl group, each of which is optionally substituted,
each R⁵ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; or (ii) each R⁵ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted, and
Z represents a bond to the NHI compound of Formula (I).

17. The electrochemical cell of claim 1, wherein R² is selected from the group consisting of C₆-C₄₀ aryl and C₅-C₄₀ heteroaryl, each of which is optionally substituted, and wherein the one or more optional substituents comprise the NHI substituent.

18. (canceled)

19. The electrochemical cell of claim 17, wherein R² is selected from the group consisting of a phenyl group, a naphthyl group, a dihydroanthracenyl group, an anthraquinonyl group, an anthracenyl group, a furyl group, a pyrrolyl group, and a thienyl group.

20. The electrochemical cell of claim 17, wherein R² is selected from the group consisting of: 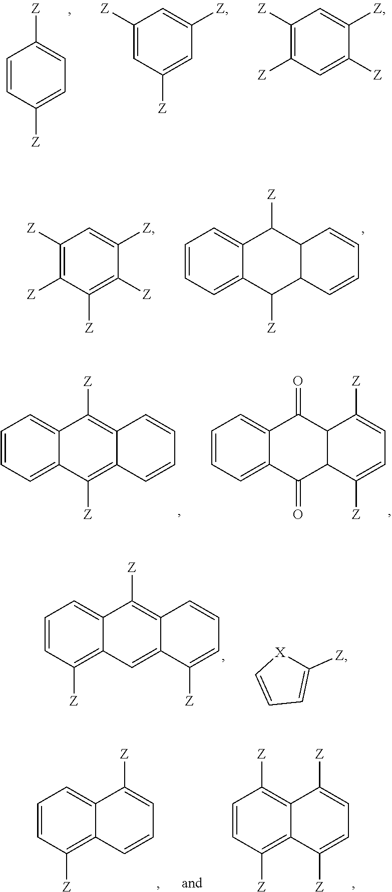
wherein:
one Z in each structure represents a bond to the NHI compound of Formula (I) and each remaining Z, if present, represents a bond to the NHI substituent, and
X is selected from the group consisting of O, N, and S.

21. The electrochemical cell of claim 1, wherein the NHI compound of Formula (I) is: 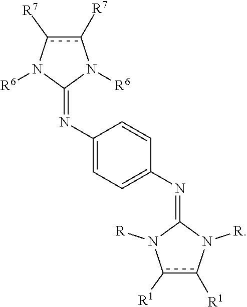
wherein:
each R is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
each R¹ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; or (ii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
each R⁶ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R⁶ combines together with at least one R⁷ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R⁶ combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted, and
each R⁷ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; or (ii) each R⁷ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted.

22. (canceled)

23. The electrochemical cell of claim 1, wherein the metal ion-stabilized derivative of the NHI compound of Formula (I) is a lithium-, a sodium-, a potassium-, a cesium-, a magnesium-, a calcium-, an aluminum-, a zinc-, and/or a cadmium-stabilized derivative of the NHI compound of Formula (I).

24. The electrochemical cell of claim 1, wherein the CO₂ adduct is stabilized by a metal ion.

25. The electrochemical cell of claim 24, wherein the metal ion comprises a lithium ion, a sodium ion, a potassium ion, a cesium ion, a magnesium ion, a calcium ion, an aluminum ion, a zinc ion, and/or a cadmium ion.

26. A method, comprising:
exposing a composition to a fluid stream suspected of comprising CO₂, wherein the composition comprises a NHI compound of Formula (I) and/or a metal ion-stabilized derivative thereof: 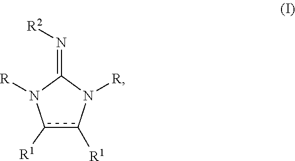
wherein:
each R is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, and N(R³)₂, each of which is optionally substituted; and/or (ii) at least one R combines together with at least one R¹ and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; and/or (iii) at least one R combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iv) each R combines together with the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
each R¹ is the same or different and: (i) is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₆-C₄₀ heteroaryl, OR³ and N(R³)₂; and/or (ii) at least one R¹ combines together with R² and the atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted; or (iii) each R¹ combines together with the carbon atoms to which they are attached to form a C₃-C₂₀ cycloalkyl group, a C₃-C₂₀ heterocycloalkyl group, a C₆-C₄₀ aryl group, or a C₅-C₄₀ heteroaryl group, each of which is optionally substituted,
R² is selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, OR³, N(R³)₂, and a NHI moiety, each of which is optionally substituted, and wherein one or more optional substituents comprise an NHC substituent, and
each R³ is the same or different and is individually selected from the group consisting of hydrogen, C₁-C₂₀ alkyl, C₂-C₂₀ alkenyl, C₃-C₂₀ alkynyl, C₃-C₂₀ cycloalkyl, C₃-C₂₀ heterocycloalkyl, C₆-C₄₀ aryl, C₅-C₄₀ heteroaryl, each of which is optionally substituted;
absorbing the CO₂, if present, from the fluid stream, wherein absorbing the CO₂ from the fluid stream comprises reacting the NHI compound of Formula (I) and/or the metal ion-stabilized derivative thereof and the CO₂ to form a CO₂ adduct; and
applying a stimulus to release the CO₂ from the CO₂ adduct and regenerate the NHI compound of Formula (I) and/or the metal ion-stabilized derivative thereof.

27-36. (canceled)

37. The method of claim 26, wherein a reduction potential of the NHI compound of Formula (I) and/or the metal ion-stabilized derivative thereof is greater than an oxygen reduction potential measured under the same conditions.

38. (canceled)

39. The method of claim 26, wherein the NHI compound of Formula (I) and/or the metal ion-stabilized derivative thereof has a redox potential greater than or equal to −1 V and less than or equal to 0.5 V vs Fc⁺/Fc.

40-43. (canceled)

44. A CO₂ sequestering agent, comprising:
a redox-active moiety comprising at least two functional groups capable of binding and releasing CO₂,
wherein the at least two functional groups, when the moiety is arranged in a set system, are configured to: (i) bind CO₂ without application of a redox-inducing electrical potential; and (ii) release bound CO₂ upon application of a stimulus, and
wherein the moiety is configured to bind and release greater than or equal to 1.4 mol of CO₂ per mol of the CO₂ sequestering agent.

45-47. (canceled)
